(19) United States
(12) Patent Application Publication
(10) Pub. No.: US 2025/0133198 A1
(43) Pub. Date: Apr. 24, 2025

(54) INFORMATION PROCESSING APPARATUS, INFORMATION PROCESSING METHOD, AND COMPUTER-READABLE RECORDING MEDIUM

(71) Applicant: SONY GROUP CORPORATION, TOKYO (JP)

(72) Inventor: MASAMOTO HORIKAWA, TOKYO (JP)

(21) Appl. No.: 18/834,462

(22) PCT Filed: Jan. 16, 2023
(86) PCT No.: PCT/JP2023/000951

§ 371 Date: Jul. 30, 2024

(30) Foreign Application Priority Data
Feb. 8, 2022 (JP) 2022-017815

(51) Int. Cl. H04N 13/344; H04N 13/125; H04N 13/15; H04N 13/156; H04N 13/398

(52) U.S. Cl. CPC H04N 13/344; H04N 13/15; H04N 13/398; H04N 13/125; H04N 13/156

(57) ABSTRACT

An information processing apparatus according to an embodiment of the present technology includes a presentation unit. The presentation unit presents a crosstalk-related image related to crosstalk due to presentation of a stereoscopic image on the basis of information about a plurality of parallax images that constitutes a stereoscopic image depending on an observation position.

### TECHNICAL FIELD

The present technology relates to an information processing apparatus, an information processing method, and a computer-readable recording medium that can be applied to a creation tool of content for a stereoscopic vision and the like.

### BACKGROUND ART

A method using a parallax of an observer is known as a method of displaying a stereoscopic image. This method is a method of respectively displaying a pair of parallax images to the left and right eyes of an observer so that the observer can stereoscopically perceive a target. Moreover, displaying parallax images suitable for an observation position of the observer can realize a stereoscopic vision that depends on the observation position.

In the method of individually displaying parallax images to the left and right eyes in this manner, for example, light from one parallax image leaks to the other parallax image and crosstalk occurs in some cases.

Patent Literature 1 has described a method of suppressing crosstalk on a display panel enabling stereoscopic display with bare eyes. In this method, a prospective angle θ of the display panel in each pixel when viewed from the observation position (viewing position) is calculated and a crosstalk amount in each pixel is calculated on the basis of a result of the calculation. Correction processing, e.g., darkening each pixel, is performed, considering such a crosstalk amount. Accordingly, the crosstalk depending on the observation position can be suppressed (specification paragraphs [0028], [0043], [0056], and [0072], FIG. 13, etc. in Patent Literature 1).

### CITATION LIST

### Patent Literature

Patent Literature 1: WO 2021/132298

### DISCLOSURE OF INVENTION

### Technical Problem

In the above-mentioned method, crosstalk estimated on the basis of a positional relationship between the display panel and the observation position can be suppressed. Meanwhile, crosstalk easily occurs due to display contents of content created for a stereoscopic vision themselves in some cases. Therefore, it is desirable to suppress crosstalk during creation of the content.

In view of the above-mentioned circumstances, it is an objective of the present technology to provide an information processing apparatus, an information processing method, and a computer-readable recording medium that are capable of supporting content creation so that crosstalk in a stereoscopic vision can be suppressed.

### Solution to Problem

In order to accomplish the above-mentioned objective, an information processing apparatus according to an embodiment of the present technology includes a presentation unit.

The presentation unit presents a crosstalk-related image related to crosstalk due to presentation of a stereoscopic image on the basis of information about a plurality of parallax images that constitutes a stereoscopic image depending on an observation position.

In this information processing apparatus, as the information about the crosstalk that occurs when the stereoscopic image is presented depending on the observation position, the crosstalk-related image is presented on the basis of the information about the plurality of parallax images that constitutes the stereoscopic image. Accordingly, it is possible to support content creation so that crosstalk in a stereoscopic vision can be suppressed.

The plurality of parallax images may include a left-eye image and a right-eye image corresponding to the left-eye image. In this case, the presentation unit may present the crosstalk-related image on the basis of a parameter of a pixel in the left-eye image and a parameter of a pixel in the right-eye image corresponding to the pixel in the left-eye image.

The stereoscopic image may be an image that displays three-dimensional content including a three-dimensional object. In this case, the presentation unit may present the crosstalk-related image on an editing screen for editing the three-dimensional content.

The presentation unit may compare the parameters of the pixels corresponding to each other in the left-eye image and the right-eye image and calculate a crosstalk-predicted region where the crosstalk is predicted to occur.

The presentation unit may present the crosstalk-predicted region as the crosstalk-related image.

The presentation unit may display an image representing the crosstalk-predicted region along the three-dimensional object on the editing screen.

The parameters of the pixels in the left-eye image and the right-eye image may include luminance of the pixels. In this case, the presentation unit may calculate a region where a luminance difference between the pixels in the left-eye image and the right-eye image exceeds a predetermined threshold as the crosstalk-predicted region.

The predetermined threshold may be set in accordance with properties of a display panel that displays the left-eye image to a left eye of an observer of the stereoscopic image and displays the right-eye image to a right eye of the observer.

The presentation unit may present, as the crosstalk-related image, crosstalk-related parameters of parameters set to the three-dimensional content, the crosstalk-related parameters being related to the crosstalk in the crosstalk-predicted region.

The crosstalk-related parameters may include at least one of color information, lighting information, or shading information of the three-dimensional object representing the pixels in the left-eye image and the right-eye image.

The presentation unit may determine a parameter of the crosstalk-related parameters, which is to be edited, and present the parameter to be edited in a highlighted manner.

The presentation unit may present the crosstalk-related image for each observation viewpoint including at least one of a left-eye viewpoint or a right-eye viewpoint depending on the observation position.

The presentation unit may calculate a cross point where a straight line toward a target pixel in the crosstalk-predicted region from the observation viewpoint initially crosses the three-dimensional object in a three-dimensional space in which the three-dimensional object and the observation viewpoint are arranged sandwiching a display surface on which the left-eye image and the right-eye image are displayed and associate the target pixel in the crosstalk-predicted region with the crosstalk-related parameters at the cross point.

The presentation unit may calculate a cross pixel where a straight line toward the observation viewpoint from a target point on the three-dimensional object is arranged at a cross point crossing the display surface in a three-dimensional space in which the three-dimensional object and the observation viewpoint are arranged by sandwiching a display surface on which the left-eye image and the right-eye image are displayed and associate the crosstalk-related parameters at the target point with the cross pixel, thereby mapping the crosstalk-related parameters on the display surface, and associate each pixel in the crosstalk-predicted region with the crosstalk-related parameters on a basis of a result of the mapping.

The presentation unit may adjust the three-dimensional content so that the crosstalk can be suppressed.

The presentation unit may acquire adjustment conditions of the three-dimensional content and adjust the three-dimensional content to satisfy the adjustment conditions.

The presentation unit may present a list of the three-dimensional object that causes the crosstalk as the crosstalk-related image.

The presentation unit may present at least one of the left-eye image or the right-eye image depending on the observation position on the editing screen.

An information processing method according to an embodiment of the present technology is an information processing method executed by a computer system and includes presenting, on the basis of the information about the plurality of parallax images that constitutes the stereoscopic image depending on the observation position, the crosstalk-related image related to the crosstalk due to presentation of the stereoscopic image.

A computer-readable recording medium according to an embodiment of the present technology records a program that causes a computer system to execute the following step. A step of presenting, on the basis of the information about the plurality of parallax images that constitutes the stereoscopic image depending on the observation position, the crosstalk-related image related to the crosstalk due to presentation of the stereoscopic image.

### BRIEF DESCRIPTION OF DRAWINGS

FIG. 1 A schematic view showing a configuration example of a content-editing apparatus according to the present embodiment.

FIG. 2 A block diagram showing a configuration example of an information processing apparatus.

FIG. 3 A schematic view showing an example of an editing screen of 3D content.

FIG. 4 A schematic view for describing an observation viewpoint of an observer.

FIG. 5 Examples of left-eye and right-eye images.

FIG. 6 Examples of the left-eye and right-eye images.

FIG. 7 A flowchart showing a basic operation of the information processing apparatus.

FIG. 8 A schematic view for describing calculation processing for a crosstalk-predicted region.

FIG. 9 A flowchart showing an example of calculation processing for crosstalk-related parameters.

FIG. 10 Schematic views for describing the processing shown in FIG. 9.

FIG. 11 A flowchart showing another example of calculation processing for the crosstalk-related parameters.

FIG. 12 A schematic view for describing the processing shown in FIG. 11.

FIG. 13 A schematic view showing a presentation example of crosstalk-related images.

FIG. 14 A block diagram showing a configuration example of an information processing apparatus according to a second embodiment.

### MODE(S) FOR CARRYING OUT THE INVENTION

Hereinafter, embodiments according to the present technology will be described with reference to the drawings.

### First Embodiment

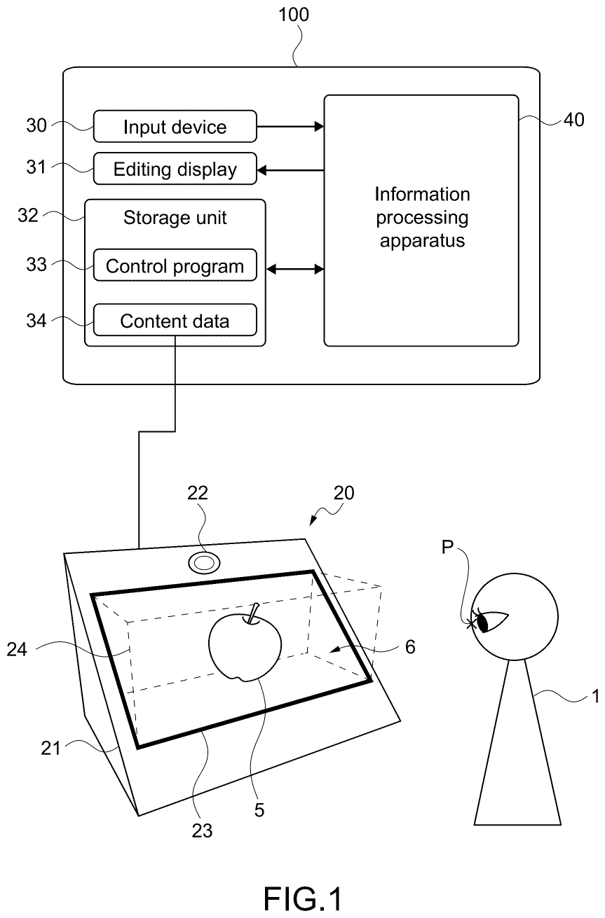

FIG. 1 is a schematic view showing a configuration example of a content-editing apparatus 100 according to the present embodiment. The content-editing apparatus 100 is an apparatus for producing and editing content for a 3D display 20 that displays a stereoscopic image. The stereoscopic image is an image that enables an observer 1 of the 3D display 20 to stereoscopically perceive the image by a stereoscopic vision.

In the present embodiment, the stereoscopic image is an image that displays 3D content 6 including a 3D object 5. That is, the content-editing apparatus 100 is an apparatus for producing and editing the 3D content 6 and is capable of editing, for example, any 3D content 6 such as a game, a movie, and a UI screen stereoscopically configured.

In the example shown in FIG. 1, a state in which the 3D object 5 representing an apple is displayed on the 3D display 20 is schematically shown. Content including an object of this apple is the 3D content 6. The use of the content-editing apparatus 100 enables a shape, a position, how to look, a motion, and the like of such an object to be edited as appropriate.

In the present embodiment, the 3D object 5 and the 3D content 6 correspond to a three-dimensional object and three-dimensional content, respectively.

### [3D Display]

The 3D display 20 is a stereoscopic display apparatus that displays a stereoscopic image depending on an observation position P of the observer 1. The 3D display 20 is configured as a stationary apparatus used placed on, for example, a table.

The observation position P of the observer 1 is a position of an observation point of the observer 1 (viewpoint of the observer 1) observing the 3D display 20, for example. The observation position P is, for example, an intermediate position between the left and right eyes of the observer 1. Alternatively, the observation position P may be a position of the face or head of the observer. In addition, how to set the observation position P is not limited. The 3D display 20 displays the 3D object 5 (3D content 6) to be visible from each observation position P in accordance with a change of the observation position P.

The 3D display 20 includes a casing portion 21, a camera 22, and a display panel 23.

The 3D display 20 has a function to estimate positions of the left and right eyes of the observer 1 by using the camera 22 provided in the main body and display different images to the left and right eyes of the observer 1 when the observer 1 views the display panel 23 from the positions. The images displayed to the left and right eyes of the observer 1 are a pair of parallax images to which a parallax has been added depending on the positions of the respective eyes.

Hereinafter, the parallax images displayed to the left and right eyes of the observer 1 will be referred to as left-eye and right-eye images, respectively. The left-eye and right-eye images are, for example, a pair of images when the 3D object 5 in the 3D content 6 is viewed from the positions corresponding to the left and right eyes.

The casing portion 21 is a casing that houses the respective units of the 3D display 20 and is used placed on a table or the like. The casing portion 21 is provided with a tilt surface tilted with respect to a placement surface. The tilt surface of the casing portion 21 is a surface on the 3D display 20, which faces the observer 1, and is provided with the camera 22 and the display panel 23.

The camera 22 is an imaging element that images the face of the observer 1 who observes the display panel 23. The camera 22 is arranged at, for example, a position so that the camera 22 can image the face of the observer 1 as appropriate. In FIG. 1, the camera 22 is arranged at an upper center position on the display panel 23 on the tilt surface of the casing portion 21.

For example, a digital camera including an image sensor such as a complementary metal-oxide semiconductor (CMOS) sensor or a charge coupled device (CCD) sensor is used as the camera 22.

A specific configuration of the camera 22 is not limited, and for example, a camera with multiple lenses, such as a stereo camera, may be used. Moreover, an infrared camera that captures an infrared image by radiating infrared light, a ToF camera that functions as a distance measurement sensor, or the like may be used as the camera 22.

The display panel 23 is a display element that displays parallax images (left-eye and right-eye images) depending on the observation position P of the observer 1. Specifically, the display panel 23 displays the left-eye image to the left eye of the observer 1 of the stereoscopic image and displays the right-eye image to the right eye of the observer 1.

The display panel 23 is, for example, a rectangular panel in a planar view and is arranged along the above-mentioned tilt surface. That is, the display panel 23 is arranged in a state tilted when viewed from the observer 1. Accordingly, the observer 1 can observe the 3D object 5 stereoscopically displayed from, for example, a horizontal direction and a perpendicular direction.

It should be noted that the display panel 23 does not necessarily need to be arranged obliquely, and the observer 1 may be arranged in any attitude as long as the observer 1 can view an image.

The display panel 23 is configured by, for example, combining a display element for displaying an image with a lens element (lens array) that controls a direction of a light beam emitted from each pixel of the display element.

For example, a display element (display) such as a liquid crystal display (LCD), a plasma display panel (PDP), or an organic electro-luminescence (EL) panel is used as the display element.

A lenticular lens that refracts a light beam emitted from the display element only to a particular direction is used as the lens element. The lenticular lens has a structure in which, for example, thin and long convex lenses are arranged adjacent to each other and is arranged so that extending directions of the convex lenses coincide with upper and lower directions of the display panel 23.

For example, the left-eye and right-eye images divided in a strip shape adapted for the lenticular lens are combined and a two-dimensional image displayed by the display element is generated. By configuring this two-dimensional image as appropriate, it is possible to respectively display the left-eye and right-eye images to the left and right eyes of the observer 1.

In addition, a display method for realizing the stereoscopic vision is not limited.

For example, another lens may be used instead of the lenticular lens. Moreover, as the display method for the parallax images, a parallax barrier method, a panel stack method, a projector array method, or the like may be used. Moreover, a polarization method of displaying parallax images through polarization eyeglasses or the like, a frame sequential method of switching and displaying parallax images per frame through liquid-crystal eyeglasses or the like, or the like may be used. In addition, the present technology can be applied to any method capable of individually displaying the parallax images to the left and right eyes of the observer.

In the 3D display 20, the observation position P of the observer 1 (the positions of the left and right eyes of the observer 1) is estimated on the basis of an image of the observer 1 captured by the camera 22. On the basis of an estimation result of this observation position P and data about the 3D content 6 (content data 34), the parallax images (left-eye and right-eye images) that the observer 1 should view are generated. These left-eye and right-eye images are displayed on the display panel 23 so that the left-eye and right-eye images can be observed from the left and right eyes of the observer 1.

In this manner, the 3D display 20 displays the left-eye and right-eye images that constitute the stereoscopic image depending on the observation position P of the observer 1. Accordingly, a stereoscopic vision (stereo stereoscopic vision) with bare eyes is realized.

Moreover, in the 3D display 20, the 3D object 5 is stereoscopically displayed in a preset virtual three-dimensional space (hereinafter, referred to as a display space 24). Thus, for example, a portion of the 3D object 5, which is present outside the display space 24, is not displayed. In FIG. 1, a space corresponding to the display space 24 is schematically shown by the dotted line.

Here, a rectangular parallelepiped-shaped space having left and right short sides of the display panel 23 as diagonal lines of its opposite surfaces is used as the display space 24. Moreover, the respective surfaces of the display space 24 are set to be surfaces parallel or orthogonal to the placement surface on which the 3D display 20 is placed. Accordingly, for example, front and rear directions, upper and lower directions, a bottom surface, or the like in the display space 24 can be easily recognized.

It should be noted that the shape of the display space 24 is not limited, and for example, can be arbitrarily set in accordance with the purpose of the 3D display 20 or the like.

### [Content-Editing Apparatus]

The content-editing apparatus 100 includes an input device 30, an editing display 31, a storage unit 32, and an information processing apparatus 40. The content-editing apparatus 100 is an apparatus used by the user (e.g., producer who produces the 3D content 6) and is typically configured as a computer such as a personal computer (PC), a work station, or a server.

It should be noted that the content-editing apparatus 100 does not need to have a function of stereoscopically displaying a display target as in the above-mentioned 3D display 20. Moreover, the present technology causes the content-editing apparatus 100 that edits the 3D content 6 to be operated, and the 3D display 20 is not essential.

The input device 30 is an apparatus for the user to perform an input operation. A device such as a mouse, a truck pad, a touch display, a keyboard, or a stylus pen is used as the input device 30. In addition, a game controller, a joystick, or the like may be used.

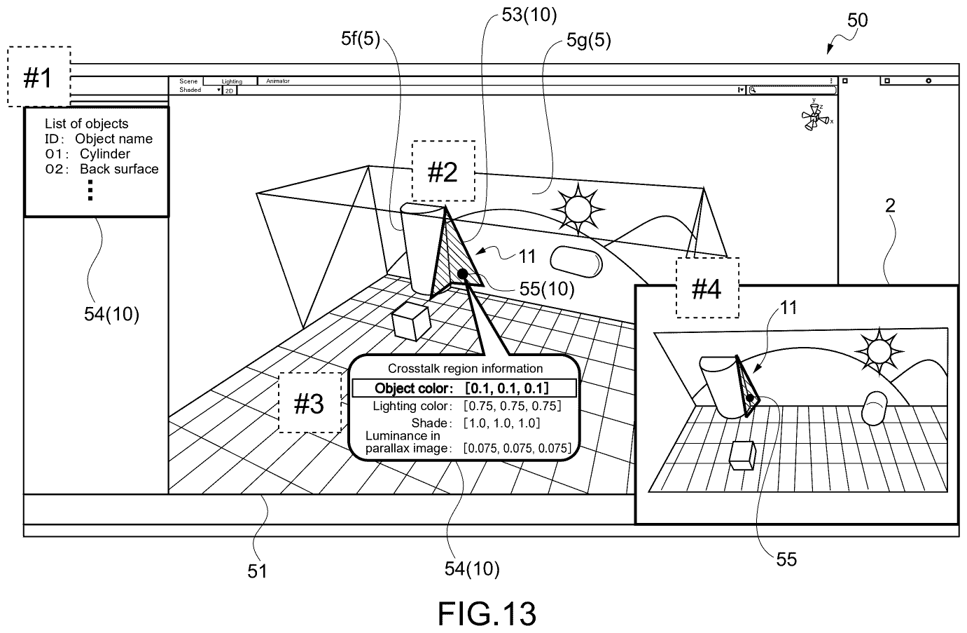

The editing display 31 is a display used by the user and the editing screen of the 3D content 6 (see FIG. 13 and the like) is displayed. The user can operate the input device 30 while looking at the editing display 31, thereby performing the editing work of the 3D content 6.

The storage unit 32 is a nonvolatile storage device, and for example, a solid state drive (SSD) or a hard disk drive (HDD) is used.

A control program 33 is stored in the storage unit 32. The control program 33 is a program that controls general operations of the content-editing apparatus 100. The control program 33 includes a program of an editing application (producing tool of the 3D content 6) for editing the 3D content 6.

Moreover, the storage unit 32 stores the content data 34 of the 3D content 6 that is an editing target. Information about a three-dimensional shape, a surface color, a lighting direction, a shade, an operation, and the like of the 3D object 5 are recorded as the content data 34.

In the present embodiment, the storage unit 32 corresponds to a computer-readable recording medium on which the program has been recorded. Moreover, the control program 33 corresponds to a program recorded on the recording medium.

### [Information Processing Apparatus]

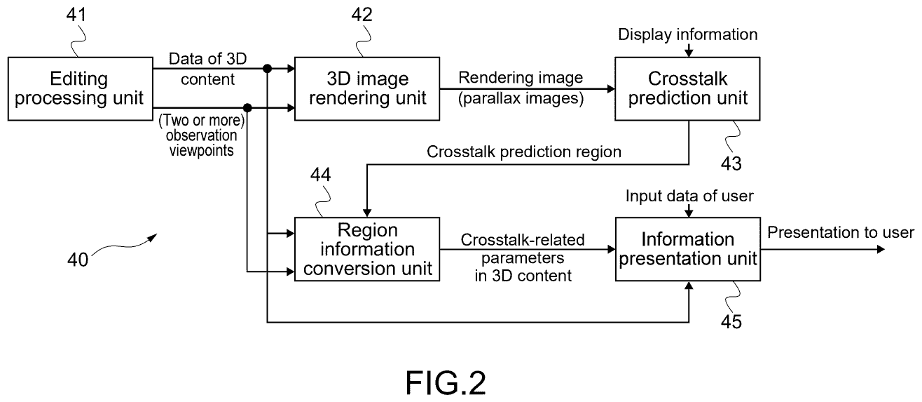

FIG. 2 is a block diagram showing a configuration example of the information processing apparatus 40.

The information processing apparatus 40 controls the operation of the content-editing apparatus 100. The information processing apparatus 40 has hardware required for a computer configuration, for example, a CPU, a memory (RAM, ROM), and the like. By the CPU loading the control program 33 stored in the storage unit 32 into the RAM and executing it, various types of processing are performed.

For example, a programmable logic device (PLD) such as a field programmable gate array (FPGA) and other devices such as an application specific integrated circuit (ASIC) may be used as the information processing apparatus 40. Moreover, for example, a processor such as a graphics processing unit (GPU) may be used as the information processing apparatus 40.

In the present embodiment, by the CPU of the information processing apparatus 40 executing the program according to the present embodiment (control program), an editing processing unit 41, a 3D image rendering unit 42, a crosstalk prediction unit 43, a region information conversion unit 44, and an information presentation unit 45 are realized as functional blocks. Then, an information processing method according to the present embodiment is executed by these functional blocks. It should be noted that dedicated hardware such as an integrated circuit (IC) may be used as appropriate in order to realize the respective functional blocks.

The information processing apparatus 40 performs processing in accordance with an editing operation of the 3D content 6 by the user and generates the data (content data 34) of the 3D content 6.

In addition, as to crosstalk that occurs in a case where the 3D content 6 as the editing target is displayed as the stereoscopic image, the information processing apparatus 40 generates information related to the crosstalk and presents the information to the user. The crosstalk can prevent comfort viewing of the observer 1. The user can produce the 3D content 6 while checking information about such crosstalk.

In the information processing apparatus 40, the observation position P in the three-dimensional space is set and a plurality of parallax images that constitutes a stereoscopic image depending on the observation position P is generated. These parallax images are generated as appropriate from, for example, information about the set observation position P and the data of the currently edited 3D content 6. Then, crosstalk-related image related to crosstalk due to presentation of the stereoscopic image is presented on the basis of the information about the plurality of parallax images.

Here, the crosstalk-related image is an image for indicating information related to the crosstalk. This image includes an image representing figures and an image displaying letters, numeric values, and the like. Therefore, it can also be said that the crosstalk-related image is information related to the crosstalk.

The user can efficiently configure content with the crosstalk suppressed by referring to the presented crosstalk-related image as appropriate. Specific contents of the crosstalk-related image will be described later in detail.

Moreover, the plurality of parallax images includes a left-eye image and a right-eye image corresponding to the left-eye image. In the present embodiment, the crosstalk-related image is presented on the basis of a parameter of a pixel in the left-eye image and a parameter of a pixel in the right-eye image corresponding to the pixel in the left-eye image.

Here, the parameters of the pixels in the left-eye and right-eye images are various properties and numeric values associated with the pixels. For example, luminance, a color, lighting, shade, type of object displayed by a pixel, a shape of the object at the pixel position, and the like are parameters of the pixel.

Hereinafter, respective functional blocks of the information processing apparatus 40 will be specifically described.

The editing processing unit 41 is a processing block that performs processing necessary for editing the 3D content 6. The editing processing unit 41 performs processing of reflecting, for example, an editing operation input by the user via the editing screen of the 3D content 6 to the 3D content. For example, editing operations as to the shape, the size, the position, the color, the operation, and the like of the 3D object 5 are received and data of the 3D object 5 is rewritten in accordance with each editing operation.

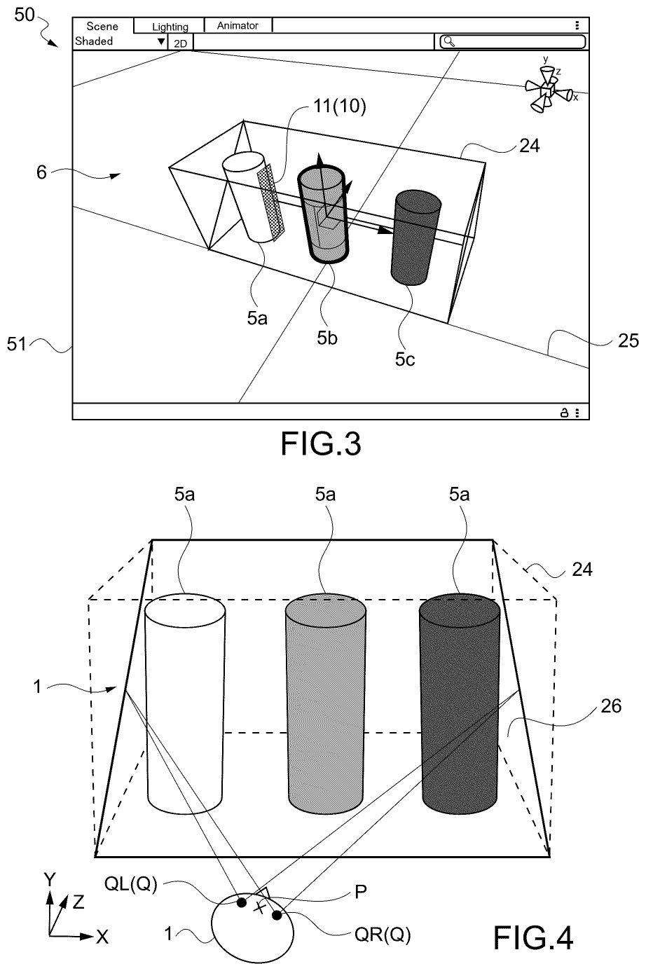

FIG. 3 is a schematic view showing an example of the editing screen of the 3D content 6.

An editing screen 50 is constituted by, for example, a plurality of windows. FIG. 3 shows a free-viewpoint window 51 that displays the display contents of the 3D content 6 at a free viewpoint as an example of the editing screen 50. In addition to such a window, the editing screen 50 includes an input window for selecting numeric values and types of the parameters, a layer window that displays layer and the like of each object, and the like. As a matter of course, the contents of the editing screen 50 are not limited.

The free-viewpoint window 51 is, for example, a window for checking the state of the currently edited content. Here, an image captured by a virtual camera in a three-dimensional space in which the 3D objects 5 are arranged is displayed. A position, an imaging direction, and imaging scale (display magnification of the 3D object 5) of the virtual camera can be arbitrarily set in accordance with an input operation made by the user with a mouse or the like.

It should be noted that the position of the virtual camera is freely set by the user viewing the editing screen and is independent of the observation position P of the 3D content 6.

As shown in FIG. 3, a reference surface 25 is set in the three-dimensional space. The reference surface 25 is, for example, a surface that is a reference in the horizontal direction for arranging the 3D object 5. Here, an X direction is set along the reference surface 25 and a Y direction is set along a direction orthogonal to the reference surface 25. Moreover, a direction orthogonal to the XY-plane is set as a Z direction.

Moreover, a rectangular parallelepiped shaped space extending in the X direction is set on the reference surface 25 as the display space 24 of the 3D display 20.

Three cylindrical-shaped 3D objects 5a, 5b, and 5c are arranged as the 3D content 6 in the display space 24. The 3D object 5a is a white object, the 3D object 5b is a grey object, and the 3D object 5c is a black object. The three 3D objects 5a, 5b, and 5c are arranged along the X direction in the stated order from the left-hand side in the figure.

In addition, the 3D content 6 includes a floor (reference surface 25) including the cylindrical-shaped 3D objects 5a to 5c, a wall, lighting that lights them up, and the like. The objects such as the cylinders and the floor in the 3D content 6, the lighting, and the color and position thereof are all editable elements.

The above-mentioned editing processing unit 41 receives, for example, an operation for editing the respective 3D objects 5a to 5c and reflects a result of the editing. For example, an operation of changing the shape, color, or the like of the 3D objects 5a to 5c, the floor, or the like, an operation of adjusting the type and direction of the lighting, an operation of moving the position, and the like can be performed. For each of these operations, the editing processing unit 41 rewrites the data of each object and records the rewritten data in the memory and the storage unit 32 as appropriate.

In this manner, the data (content data 34) of the content produced through the editing work is recorded, for example, as data of three-dimensional computer graphics (CG).

Referring back to FIG. 3, the 3D image rendering unit 42 performs rendering processing on the data of the 3D content 6 and generates an image (rendering image) when the 3D content 6 is viewed from an observation viewpoint Q.

For example, the data of the 3D content 6 generated by the editing processing unit 41 and data indicating two or more observation viewpoints Q are input to the 3D image rendering unit 42. Based on such data, a rendering image group that should be displayed on the display surface (display panel 23) of the 3D display 20 when the 3D content is viewed from each observation viewpoint Q is generated.

FIG. 4 is a schematic view for describing the observation viewpoints Q of the observer 1. In FIG. 4, the observer 1 observing the 3D content 6 edited on the editing screen 50 shown in FIG. 3 is schematically shown. Hereinafter, the surface corresponding to the display panel 23 (surface on which the parallax images are displayed) in the display space 24 in which the 3D content 6 is configured will be referred to as a display surface 26. The display surface 26 is a surface tilted with respect to the reference surface 25.

The observation viewpoint Q is a position of a single eyeball viewing the 3D content 6. For example, positions of the left and right eyes of the single observer 1 in the three-dimensional space are the observation viewpoints Q of the observer 1. Hereinafter, the observation viewpoint Q corresponding to the left eye of the observer 1 will be referred to as a left-eye viewpoint QL and the observation viewpoint Q corresponding to the right eye will be referred to as a right-eye viewpoint QR.

The left-eye viewpoint QL and the right-eye viewpoint QR are calculated, for example, on the basis of the observation position P. When the observation position P is set on the editing screen 50, the left-eye viewpoint QL and the right-eye viewpoint QR are calculated on the basis of a positional relationship between the observation position P and the left and right eyes.

In the example shown in FIG. 4, an intermediate position between the left and right eyes of the observer 1 is set as the observation position P. Moreover, it is assumed that the observer 1 has a line of sight directed to the center of the display space 24 (the center of the display surface 26). In this case, the direction toward the center of the display space 24 from the observation position P is set as a line-of-sight direction of the observer 1.

For example, the position moving to the left-hand side (or right-hand side) by a predetermined shift amount along a direction orthogonal to the line-of-sight direction while maintaining the height position (Y-coordinate) from the observation position P is set as the left-eye viewpoint QL (or the right-eye viewpoint QR). The shift amount at this time is set to be, for example, a value that is a half of an assumed distance between the pupils of the observer 1.

In addition, a calculation method for the left-eye viewpoint QL and the right-eye viewpoint QR is not limited. For example, in a case where the center position of the face or the position of the center-of-weight of the head of the observer 1 is set as the observation position P, the left-eye viewpoint QL and the right-eye viewpoint QR are calculated as appropriate in accordance with a positional relationship with the observation position P. Alternatively, a method in which the user directly specifies the positions of the left-eye viewpoint QL and the right-eye viewpoint QR with a mouse cursor or the like or a method in which the user directly inputs a coordinate value of each viewpoint may be used.

The 3D image rendering unit 42 acquires one or more sets of coordinate data of the left-eye viewpoint QL and the right-eye viewpoint QR and generates a pair of parallax images for each set of coordinate data.

The parallax images include a rendering image (left-eye image) for the left eye and a rendering image (right-eye image) for the right eye. These parallax images are generated on the basis of the data of the 3D content 6 and the estimated positions (left-eye viewpoint QL and right-eye viewpoint QR) of the left and right eyes of the observer 1.

It should be noted that in the present embodiment, it is possible to set the plurality of observation positions P. In this case, a set of coordinate data of the left-eye viewpoint QL and the right-eye viewpoint QR is generated for each plurality of observation positions P and the pair of parallax images is rendered for each observation position P.

Referring back to FIG. 3, the crosstalk prediction unit 43 calculates a crosstalk-predicted region where crosstalk is predicted to occur when the rendered parallax images (left-eye and right-eye images) is displayed on the 3D display 20.

Here, the crosstalk-predicted region is a region where the crosstalk on the display surface 26 (display panel 23) of the 3D display 20 can occur and can be represented as pixel regions in the parallax images.

For example, the left-eye and right-eye images generated by the 3D image rendering unit 42 are input to the crosstalk prediction unit 43. Based on such data, the crosstalk-predicted region where the crosstalk can occur is calculated.

Specifically, the crosstalk prediction unit 43 compares the parameters of the pixels corresponding to each other in the left-eye and right-eye images generated by the 3D image rendering unit 42 and calculates the crosstalk-predicted region.

The left-eye and right-eye images are typically images with the same pixel size (resolution). Thus, the pixels corresponding to each other in the left-eye and right-eye images are pixels that are the same coordinates (pixel position) in each image. This pair of pixels is pixels displayed at substantially the same position on the display surface 26 (display panel 23).

As to the pair of pixels corresponding to each other, the crosstalk prediction unit 43 determines whether or not the crosstalk will occur at that pixel position by comparing the parameters at the respective pixels. This processing is performed on all pixel positions and a set of pixels in which the crosstalk has been determined to occur is calculated as the crosstalk-predicted region.

Moreover, the information (display information) of the 3D display 20 that can be used for viewing the 3D content 6 is input to the crosstalk prediction unit 43. In determination processing for the crosstalk, determination conditions and the like are set by referring to this display information.

An operation of the crosstalk prediction unit 43 will be described later in detail.

The region information conversion unit 44 associates the crosstalk-predicted region with an element of the 3D content 6 related to the crosstalk.

For example, the crosstalk-predicted region predicted by the crosstalk prediction unit 43, the data of the 3D content 6, and the data of the observation viewpoint Q are input to the region information conversion unit 44. Based such data, data in which various elements that constitute the 3D content 6 are associated with the crosstalk-predicted region is calculated.

Specifically, the region information conversion unit 44 calculates crosstalk-related parameters of the parameters set to the 3D content 6, which is related to the crosstalk in the crosstalk-predicted region. For example, parameters of the parameters of the pixels, which have caused the crosstalk, are calculated as the crosstalk-related parameters. It should be noted that types of parameters as the crosstalk-related parameters may be set in advance or may be set in accordance with a state and the like of the crosstalk.

Moreover, as it will be described later, the crosstalk-related parameters are calculated for each pixel included in the crosstalk-predicted region in the present embodiment. Therefore, it can also be said that the region information conversion unit 44 generates data by mapping the crosstalk-related parameters in the crosstalk-predicted region.

The information presentation unit 45 presents the crosstalk-related image related to the crosstalk to the user using the content-editing apparatus 100.

For example, the data of the 3D content 6 and the data of the crosstalk-related parameters associated with the 3D content 6 are input to the information presentation unit 45. Moreover, input data of the user, data of the observation position P, and data of the crosstalk-predicted region are input to the information presentation unit 45. A crosstalk-related image is generated using such data and is presented to the user.

It should be noted that the input data of the user is data input by the user for presenting the crosstalk-related image. The input data includes, for example, data specifying coordinates and the like of a point in the 3D content 6, gazed by the user, data specifying a display item of the crosstalk-related image, and the like.

In the present embodiment, the information presentation unit 45 presents the crosstalk-related image on the editing screen 50 for editing the 3D content 6. That is, information about the crosstalk that has occurred on the basis of the prediction of the crosstalk is presented on the editing screen 50. The method of presenting the crosstalk-related image is not limited. For example, the crosstalk-related image is generated as the image data added to the editing screen 50. Alternatively, the editing screen 50 itself may be generated to include the crosstalk-related image.

In the present embodiment, the crosstalk-predicted region is presented as the crosstalk-related image. Moreover, the crosstalk-related parameters are presented as the crosstalk-related image.

For example, on the editing screen 50 (free-viewpoint window 51) shown in FIG. 3, a crosstalk-predicted region 11 is displayed as a dotted region as an example of a crosstalk-related image 10. Moreover, the image representing the crosstalk-related parameters is displayed on the editing screen 50 as the crosstalk-related image 10.

Since the user who produces the 3D content 6 can perform the editing work while viewing the crosstalk-related image 10 (crosstalk-predicted region 11 and crosstalk-related parameters), the user can easily create content with crosstalk suppressed. Moreover, presenting the crosstalk-related image 10 can make it possible to encourage the user to create content considering crosstalk.

The crosstalk-related image will be described later in detail with reference to FIG. 13 and the like.

Moreover, the information presentation unit 45 presents the crosstalk-related image 10 for each observation viewpoint Q (e.g., left-eye viewpoint QL and right-eye viewpoint QR).

In general, when the observation viewpoint Q changes, the state of the crosstalk visible from that viewpoint changes. Therefore, for example, crosstalk visible from the left-eye viewpoint QL and crosstalk visible from the right-eye viewpoint QR are considered to differ from each other in a region where the crosstalk occurs or a cause of the crosstalk.

In view of this, the information presentation unit 45 presents the crosstalk-related image 10 corresponding to the left-eye viewpoint QL in a case where the left-eye viewpoint QL has been selected and presents the crosstalk-related image 10 corresponding to the right-eye viewpoint QR in a case where the right-eye viewpoint QR has been selected. Accordingly, the user can sufficiently check information about the crosstalk.

In the present embodiment, the crosstalk prediction unit 43, the region information conversion unit 44, and the information presentation unit 45 cooperate to realize the presentation unit.

### [Crosstalk]

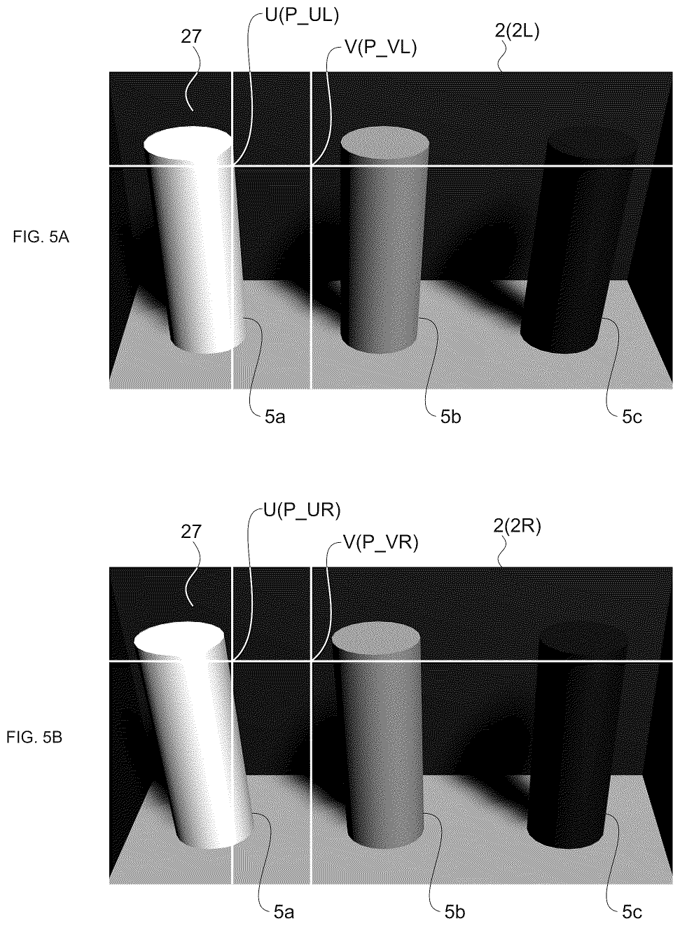

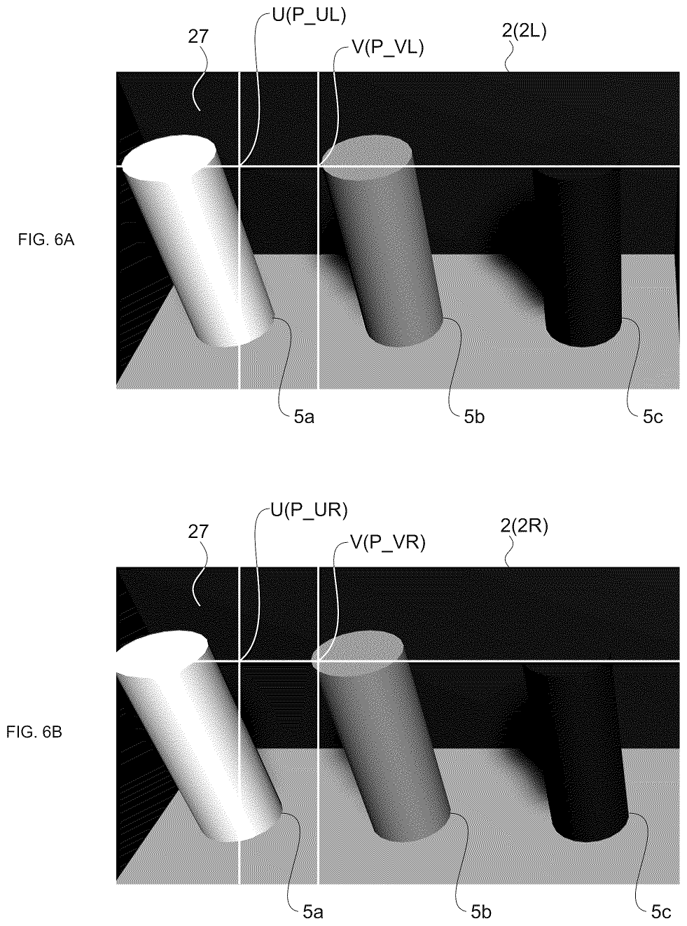

FIGS. 5 and 6 are examples of the left-eye and right-eye images. The observation position P of the observer 1 differs between FIGS. 5 and 6. In FIG. 5, the observation position P is set on the front upper side of the display space 24 (3D display 20). Moreover, in FIG. 6, the observation position P that has moved on the right-hand side of the display space 24 (3D display 20) than the observation position P set in FIG. 5 is set.

A of FIG. 5 (A of FIG. 6) shows a left-eye image 2L displayed to the left eye (left-eye viewpoint QL) of the observer 1 located at the observation position P. B of FIG. 5 (B of FIG. 6) shows a right-eye image 2R displayed to the right eye (right-eye viewpoint QR) of the observer 1 located at the observation position P.

Moreover, A of FIG. 5, B of FIG. 5, A of FIG. 6, and B of FIG. 6 respectively show coordinates U and coordinates V representing the same pixel position.

In a case of displaying parallax images 2 (left-eye image 2L and right-eye image 2R) on the 3D display 20, it is known that a phenomenon called crosstalk occurs. The crosstalk is a phenomenon in which the contents of the respective parallax images 2 are mixed in each other and can occur in a case where the contents of the respective parallax images 2 are different in the display surface (display panel 23) of the 3D display 20.

For example, as shown in A of FIG. 5 and B of FIG. 5, the left-eye image 2L and the right-eye image 2R are not the same images because the viewpoint positions Q are different. The respective images are displayed on the display panel 23 of the 3D display 20 so that the left-eye image 2L is visible from the left-eye viewpoint QL and the right-eye image 2R is visible from the right-eye viewpoint QR. At this time, the ranges in which the left-eye image 2L and the right-eye image 2R are displayed substantially overlap each other on the display panel 23.

Therefore, for example, the position on the display panel 23 where the pixel P_UL in the left-eye image 2L positioned at the coordinates U is displayed substantially overlaps the position where a pixel P_UR in the right-eye image 2R also positioned at the coordinates U is displayed. Therefore, for example, when the pixel P_UL in the left-eye image 2L is viewed from the left-eye viewpoint QL, light at the pixel P_UR in the right-eye image 2R can look mixed. In contrast, when the pixel P_UR in the right-eye image 2R is viewed from the right-eye viewpoint QR, light at the pixel P_UL in the left-eye image 2L looks mixed.

In this manner, when pixel light that should not be visible is mixed and such light is noticeable, the observer 1 perceives the light as crosstalk.

For example, as shown in A of FIG. 5, the pixel P_UL at the coordinates U in the left-eye image 2L is a pixel representing the surface of the white 3D object 5a and its luminance is sufficiently higher than (a wall surface 27) that is the background. Meanwhile, as shown in B of FIG. 5, the pixel P_UR at the coordinates U in the right-eye image 2R is a pixel representing the wall surface 27 that is the background. Thus, it can be seen that a luminance difference between the pixel P_UL and the pixel P_UR is sufficiently high.

For example, when the coordinates U are viewed from the right-eye viewpoint QR, only the dark background should be displayed, but white light from the pixel P_UL in the left-eye image 2L is mixed and crosstalk occurs. This is an example of crosstalk that occurs when brightly displayed pixel light leaks at a darkly displayed pixel. For example, a region (region with a larger luminance difference) of the region representing the background in the one parallax image 2, which overlaps the cylindrical portion brightly displayed in the other parallax image 2 is brighter than a region (region with a smaller luminance difference) that overlaps the background of the other parallax image 2, and the crosstalk is more easily perceived.

Moreover, when the coordinates U are viewed from the left-eye viewpoint QL, they are darker because white light from the pixel P_UL leaks to the pixel P_UR and at the same time, light that leaks from the darker pixel P_UR is smaller in amount. Therefore, the crosstalk is perceived also when the coordinates U are viewed from the left-eye viewpoint QL. This is an example of crosstalk that occurs because brightly displayed pixel light leaks and also light that leaks to that pixel is smaller in amount. For example, a region (region with a larger luminance difference) of a region representing the cylindrical portion brightly displayed in the one parallax image 2, which overlaps the background of the other parallax image 2, is darker than a region (region with a smaller luminance difference) that overlaps the cylindrical portion brightly displayed in the other parallax image 2, and the crosstalk is more easily perceived.

It should be noted that between a case where the pixel is brighter (in A of FIG. 5, a case where the coordinates U are viewed from the right-eye viewpoint QR) and a case where the pixel is darker (in A of FIG. 5, a case where the coordinates U are viewed from the left viewpoint QL), the likelihood to perceive it can differ even with the same amount of leakage.

Moreover, a pixel P_VL in the left-eye image 2L positioned at the coordinates V and a pixel P_VR of the right-eye image 2R also positioned at the coordinates V are both pixels representing the wall surface 27 that is the background and their luminance are both lower. Thus, a luminance difference between the pixel P_VL and the pixel P_VR is relatively low. In this case, no crosstalk which could be perceived by the user occurs at the coordinates V both from the left-eye viewpoint QL and the right-eye viewpoint QR.

In this manner, in a case where the luminance difference between the pixels corresponding to each other in the left-eye image 2L and the right-eye image 2R is sufficiently larger, crosstalk can occur at these pixels. Moreover, even in a case where there is no luminance difference, the degree to perceive the crosstalk differs depending on differences in luminance level and color. Thus, crosstalk can occur in different regions in the left-eye image 2L and the right-eye image 2R.

It should be noted that a region where the luminance difference between the pixels corresponding to each other is relatively low in the left-eye image 2L and the right-eye image 2R is a region where the crosstalk is unlikely to be perceived.

Moreover, the position where crosstalk occurs changes when the observation position P changes. For example, as shown in A of FIG. 6 and B of FIG. 6, when the display space 24 is viewed from the obliquely upper right, the pixel P_UL in the left-eye image 2L and the pixel P_UR in the right-eye image 2R that are displayed at the coordinates U are both pixels representing the wall surface 27. Therefore, in FIG. 6, a luminance difference between the pixel P_UL and the pixel P_UR is small and no crosstalk is perceived at the coordinates U.

Meanwhile, in FIG. 6, the pixel P_VL in the left-eye image 2L displayed at the coordinates V is a pixel representing the wall surface 27 while the pixel P_VR in the right-eye image 2R displayed at the coordinates V is a pixel representing the surface of the grey 3D object 5b. Therefore, in a case where a luminance difference between the pixel P_VL and the pixel P_VR is sufficiently large, the light from the pixel P_VR in the right-eye image 2R is mixed and crosstalk can occur when the coordinates V are viewed from the left-eye viewpoint QL.

Moreover, when the coordinates V are viewed from the right-eye viewpoint QR, they are darker because light from the pixel P_VR in the right-eye image 2R leaks to the pixel P_UR and at the same time, light that leaks from the pixel P_VL is darker. Therefore, also when the coordinates V are viewed from the right-eye viewpoint QR, crosstalk can be perceived.

Moreover, how light is mixed at each pixel differs also depending on a configuration of the hardware (display panel 23) that displays the left-eye image 2L and the right-eye image 2R. For example, in accordance with properties of a lens array such as lenticular lenses, pixel size, and the like, the amount of leakage of light at the pixel displayed at the same coordinates (degree by which light is mixed) differs. Therefore, for example, in a case where the display panel 23 with a smaller amount of leakage of light is used, crosstalk cannot be perceived even in a case where the luminance difference is relatively large. In contrast, in a case where the display panel 23 with a larger amount of leakage of light is used, crosstalk can be perceived even when the luminance difference is relatively small.

In this manner, a degree of influence on comfort of viewing when the viewer perceives crosstalk depends on the group of parallax images (left-eye image 2L and right-eye image 2R) generated depending on each viewpoint position P, 3D content that is a source for the group of parallax images, and factors associated with the hardware of the 3D display 20.

In the present embodiment, information regarding the crosstalk is calculated in consideration of such information.

### [Basic Operation]

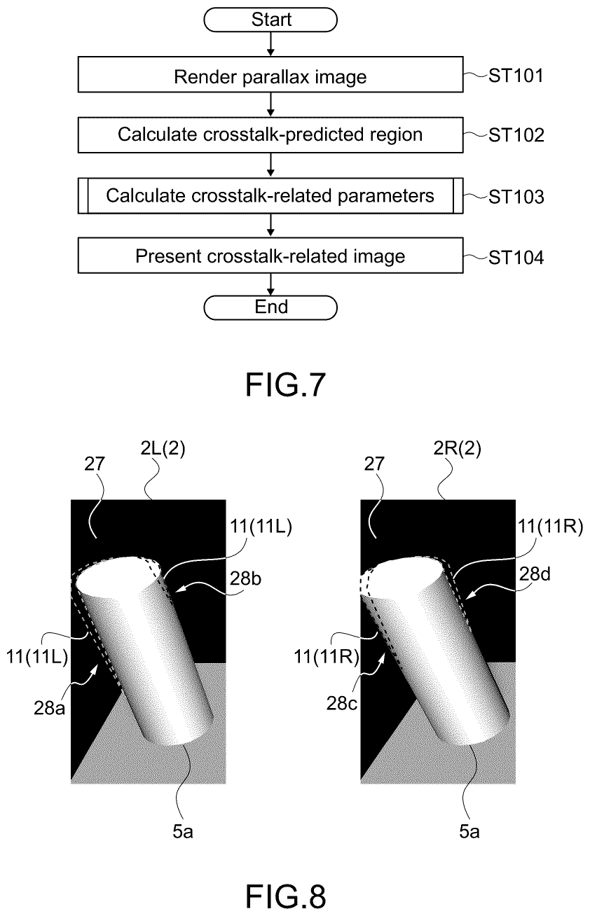

FIG. 7 is a flowchart showing a basic operation of the information processing apparatus. The processing shown in FIG. 7 is processing performed in a case where processing of presenting the crosstalk-related image 10 has been selected on, for example, the editing screen 50. Moreover, in a case where the crosstalk-related image 10 is constantly presented, the processing shown in FIG. 7 may be performed every time processing of editing the 3D content 6 is performed.

First of all, the 3D image rendering unit 42 renders the parallax images 2 (left-eye image 2L and right-eye image 2R) (Step 101). In this processing, the data of the currently edited 3D content 6 and the data of the observation viewpoint Q are read. Then, images representing the 3D content 6 when viewed from the respective observation viewpoints Q are generated as the parallax images 2. Specifically, the left-eye image 2L and the right-eye image 2R to be displayed to the left-eye viewpoint QL and the right-eye viewpoint QR are generated.

Next, the crosstalk prediction unit 43 calculates the crosstalk-predicted region 11 (Step 102). In this processing, the left-eye image 2L and the right-eye image 2R generated in Step 101 and display information are read. Then, with respect to the respective pixels in the left-eye image 2L and the right-eye image 2R, whether or not crosstalk occurs is determined. Determination conditions at this time are set in accordance with the display information. The region formed by a pixel for which crosstalk has been determined to occur is calculated as the crosstalk-predicted region 11.

Next, the region information conversion unit 44 calculates crosstalk-related parameters (Step 103). This is processing of calculating a crosstalk-predicted region and correspondence of elements in the 3D content that cause the crosstalk in order to determine the elements (parameters) that can cause the crosstalk. Specifically, data of the crosstalk-predicted region 11, data of the 3D content 6, and data of the observation viewpoint Q are read. Based on such data, crosstalk-related parameters are calculated with respect to all pixels that constitute the crosstalk-predicted region 11 and map data about the crosstalk-related parameters is generated. This map data is recorded on the memory or the storage unit 32 as appropriate.

Next, the information presentation unit 45 presents the crosstalk-related image 10 to the editing screen 50 (Step 104).

For example, image data representing the crosstalk-predicted region 11 is generated as the crosstalk-related image and displayed in the free-viewpoint window 51.

Moreover, for example, image data including a text and the like representing the crosstalk-related parameters is generated as the crosstalk-related image and displayed in a dedicated window. In this case, for example, a pixel corresponding to a point specified by the user is determined and crosstalk-related parameters corresponding to the specified pixel are presented based on the map data generated in Step 103.

Accordingly, it is possible to support content creation so that crosstalk in a stereoscopic vision can be suppressed.

### [Crosstalk-Predicted Region]

Hereinafter, calculation processing for the crosstalk-predicted region 11 by the crosstalk prediction unit 43 which is performed in Step 102 will be described.

FIG. 8 is a schematic view for describing calculation processing for the crosstalk-predicted region 11. The pictures on the left-hand side and the right-hand side in FIG. 8 are pictures enlarging the 3D object 5a included in the left-eye image 2L and the right-eye image 2R shown in FIG. 6. Here, the crosstalk-predicted regions 11 calculated with respect to the left-eye image 2L and the right-eye image 2R are schematically shown as dotted-line regions.

As described above, the parameters of the pixels in the left-eye image 2L and the right-eye image 2R are included in the luminance of the pixels. The crosstalk prediction unit 43 calculates the crosstalk-predicted region 11 by comparing luminance of the pixels corresponding to each other in the left-eye image 2L and the right-eye image 2R. Specifically, the crosstalk prediction unit 43 calculates a region where a difference between the luminance of the pixels of the left-eye image 2L and the right-eye image 2R exceeds a predetermined threshold as the crosstalk-predicted region 11.

First of all, processing of calculating a crosstalk-predicted region 11L with respect to the left-eye image 2L will be described. The crosstalk prediction unit 43 reads a luminance value αL of a pixel in the left-eye image 2L and a luminance value αR of a pixel in the right-eye image 2R which is located at the same pixel position as that pixel. Then, a luminance difference δ=αL−αR between the luminance value αL and the luminance value αR is calculated.

Next, a determination as to the luminance difference δ is made by using a predetermined threshold δt. Here, it is assumed that the threshold δt is set to be a positive value. For example, whether or not an absolute value of the luminance difference δ is equal to or larger than the threshold δt is determined. In a case where |δ|≥δt, the luminance difference δ between αL and αR is sufficiently large, and thus crosstalk is determined to occur at the pixel in the left-eye image 2L.

Moreover, the threshold δt may be changed between a case where δ is positive and a case where δ is negative. For example, in a case where δ is positive, αL>αR is established and the pixel can be darker in the left-eye image 2L. In this case, whether or not δ≥δt⁺ is established is determined by using a threshold δt⁺ for crosstalk that occurs when the pixel is darker. Moreover, in a case where δ is negative, αL<αR is established and the pixel can be brighter in the left-eye image 2L. In this case, whether or not δ≤−δt⁻ is established is determined by using a threshold δt⁻ for crosstalk that occurs when the pixel is brighter.

Such processing is performed with respect to all pixel positions. The pixel in the left-eye image 2L where the crosstalk is determined to occur is set as the crosstalk-predicted region 11L in the left-eye image 2L.

For example, in the left-eye image 2L shown in FIG. 8, a region 28a of the 3D object 5a in the region where the wall surface 27 that is the background is displayed, which is in contact with the left-hand side in the figure, is a region where light of the 3D object 5a displayed in the right-eye image 2R is mixed. For example, in the respective pixels included in the region 28a, the luminance difference δ is negative and it is determined that δ≤−δt⁻ is established. In this case, the region 28a is the crosstalk-predicted region 11L where the pixel is brighter in the left-eye image 2L.

Similarly, in the left-eye image 2L, the background of the right-eye image 2R is displayed to overlap in a region 28b of the 3D object 5a in the region where the 3D object 5a is displayed, which is in contact with the background on the right-hand side in the figure. For example, in the respective pixels included in the region 28b, the luminance difference δ is positive and it is determined that δ≥δt⁺ is established. In this case, the region 28b is the crosstalk-predicted region 11L where the pixel is darker in the left-eye image 2L.

The processing of calculating a crosstalk-predicted region 11R with respect to the right-eye image 2R is performed as in the crosstalk-predicted region 11L in the left-eye image 2L. Here, for example, a luminance difference δ=αR−αL between the luminance value αR and the luminance value αL (reference sign opposite to that in the case of the left-eye image 2L) is calculated.

For example, in the right-eye image 2R shown in FIG. 8, the background of the left-eye image 2L is displayed in a region 28c of the 3D object 5a in the region where the 3D object 5a is displayed, which is in contact with the background on the left-hand side in the figure. For example, in the respective pixels included in the region 28c, the luminance difference δ is positive and it is determined that δ≥δt⁺ is established. In this case, the region 28c is the crosstalk-predicted region 11R in which the pixel is darker in the right-eye image 2R.

Similarly, in the right-eye image 2R, a region 28d of the 3D object 5a in the region where the background is displayed, which is in contact with the right-hand side in the figure, is a region where light of the 3D object 5a displayed in the left-eye image 2L is mixed. For example, in the respective pixels included in the region 28d, the luminance difference δ is negative and it is determined that δ≤−δt⁻ is established. In this case, the region 28d is the crosstalk-predicted region 11R in which the pixel is brighter in the right-eye image 2R.

Hereinabove, the example in which the different thresholds δt⁺ and δt⁻ are used in a case where δ is positive and a case where δ is negative has been described. In this method, as shown in FIG. 8, different crosstalk-predicted regions 11 are calculated for the left-eye image 2L and the right-eye image 2R.

Not limited thereto, a common threshold δt may be used irrespective of whether δ is positive or negative. In this case, the crosstalk-predicted region 11 is the same region in the left-eye image 2L and the right-eye image 2R. Therefore, the crosstalk-predicted region 11 in the left-eye image 2L and the right-eye image 2R can be calculated with single processing, and the processing load can be reduced.

Moreover, depending on a content type and a scene, crosstalk where the pixel is brighter (or crosstalk where the pixel is darker) may be mainly perceived. In such a case, the crosstalk-predicted region 11 may be calculated only with respect to a case where δ is negative (or a case where δ is positive).

In the present embodiment, the predetermined threshold δt is set in accordance with the properties of the display panel 23.

As described above with reference to FIGS. 5 and 6 and the like, how light is mixed at each pixel differs depending on a configuration of the display panel 23 which is hardware.

For example, in the display panel 23 with a smaller amount of leakage of light, the other pixel light hardly leaks. Therefore, the crosstalk is not perceived unless the luminance difference δ becomes relatively large. In this case, the threshold δt for the luminance difference δ is set to be larger.

In contrast, in the display panel 23 with a larger amount of leakage of light, the other pixel light easily leaks. Therefore, even in a case where the luminance difference δ is relatively small, crosstalk can be perceived. In this case, the threshold δt for the luminance difference δ is set to be smaller.

By setting the threshold δt for the luminance difference δ in accordance with the properties of the display panel 23 in this manner, it is possible to accurately calculate the crosstalk-predicted region 11.

Accordingly, for example, it is possible to prevent the situation where a region where no crosstalk will occur is calculated as the crosstalk-predicted region 11 or the situation where a region where crosstalk is highly likely to occur is excluded from the crosstalk-predicted region 11. Moreover, the user can create the 3D content 6 on the basis of highly-accurate prediction of the crosstalk, and thus adjustment and the like of the content can be properly performed.

Hereinabove, the method of calculating the crosstalk-predicted region 11 by determining the luminance difference δ with the threshold has been described. However, the crosstalk-predicted region 11 may be calculated by the other method.

For example, the determination conditions with respect to the luminance value of each pixel may be set. For example, even with the same luminance difference δ, there is a case where the luminance difference δ is noticeable or a case where the luminance difference δ is less noticeable, depending on the luminance value of each pixel. Therefore, processing of setting the threshold of the luminance difference δ to be smaller in a case where the luminance value of each pixel is within such a range that the luminance difference is noticeable or setting the threshold of the luminance difference δ to be larger in a case where the luminance value of each pixel is within such a range that the luminance difference is less noticeable may be performed. Accordingly, it is possible to accurately calculate the crosstalk-predicted region 11.

Moreover, it is considered that the degree to perceive the crosstalk depends on the brightness of the entire screen. In this case, processing of setting the threshold of the luminance difference δ to be smaller as the crosstalk is more easily perceived is performed.

Moreover, whether or not the crosstalk will occur may be determined by comparing parameters other than the luminance difference δ (luminance value). For example, when light in red, blue, and the like is mixed in a pixel displayed in white, the crosstalk is more easily perceived. On the basis of a color difference at the pixel corresponding to the left-eye image 2L and the right-eye image 2R, the crosstalk-predicted region 11 may be calculated. Moreover, the crosstalk-predicted region 11 may be calculated combining the above-mentioned methods.

In addition, a method of calculating the crosstalk-predicted region 11 is not limited.

### [Crosstalk-Related Parameters]

Hereinafter, the crosstalk-related parameters will be described.

In the present embodiment, the information presentation unit 45 presents the information about the 3D content 6 to the user so that the information about the 3D content 6 serves to reduce the crosstalk. A point here is an element presented to the user.

In general, the 3D content 6 includes many elements that the user can edit and a number of elements are considered even only with an element associated with the crosstalk. For example, in a case where such elements are presented to all users, there is a possibility that the user does not know which element should be edited, and it does not serve to reduce the crosstalk as a result.

In view of this, an element that should be presented considering the occurrence of crosstalk is considered. As described above, the place where crosstalk easily occurs is a place where the luminance difference δ becomes larger between the parallax images 2 (left-eye image 2L and right-eye image 2R). Thus, it can be said that the luminance of the parallax images 2 is elements that largely acts on the crosstalk.

Moreover, when generating the parallax images 2 from the 3D content 6, the luminance of the parallax images 2 is often considered with a model based on a rendering equation represented by the following expression (1).

$$\begin{matrix}[ Expression 1 ] & \\ {L}_{o} ( x , {ω}_{o} ) = {L}_{e} ( x , {ω}_{o} ) + {\int }_{Ω} {f}_{r} ( x , {ω}_{o} , {ω}_{i} ) {L}_{i} ( x , {ω}_{i} ) \vert {ω}_{i} \cdot n \vert d {ω}_{i} & ( 1 )\end{matrix}$$

Here, x denotes the position of the observation target (e.g., the position of the surface of the 3D object 5) and ω₀ denotes a direction to observe a position x.

L₀(x, ω₀) denotes luminance when a certain position x is viewed from a certain direction ω₀.

Lₑ(x, ω₀) denotes luminance when self light emission in the direction wo is performed at the position x of the 3D object 5.

fᵣ(x, ω₀, ωᵢ) denotes reflection light reflected in a direction ωᵢ after it enters an object from the direction ωᵢ and depends on the color of the object.

L(x, ωᵢ) denotes brightness of the lighting that enters the position x from the direction ωᵢ.

n denotes a normal line at the position x and |n*ωᵢ| denotes a shade at the position x.

Moreover, the interval of integration Ω means that the direction ωᵢ is integrated over the whole globe.

As it can be seen from the expression (1), although the details are different, it is calculated by adding a value obtained by multiplying the color of the 3D object 5, light that lights up the 3D object 5, and a shade generated on the 3D object 5 to the luminance of light emitted by the 3D object 5 itself when calculating the luminance of the parallax images 2. Thus, these elements directly related to the luminance are elements that should be presented to the user. In the present technology, these elements are presented to the user as crosstalk-related parameters.

The crosstalk-related parameter include at least one of the color information, the lighting information, or the shading information of the 3D object 5 represented by the pixels in the left-eye and right-eye images.

Typically, all such information is extracted for each pixel as crosstalk-related parameters and is presented on the editing screen 50. It should be noted that one or two elements of them may be extracted as crosstalk-related parameters.

The color information of the 3D object 5 is information representing the color set to the object surface.

The lighting information of the 3D object 5 is information representing the color of the lighting. It should be noted that an irradiation direction and the like of the lighting may be used as the lighting information.

The shading information of the 3D object 5 is information representing the color of the shade formed on the object surface. It should be noted that the shape (direction of a normal line n) or the like of the 3D object 5 at the position x of interest may be used as the shading information.

Moreover, values of colors included in the color information, the lighting information, the shading information are represented by gradation of RGB colors, for example. In addition, a method of representing the colors is not limited.

In this manner, in the present embodiment, on the basis of a general calculation method in creating the parallax images 2 from the 3D content 6 (the 3D object 5), the color of the 3D object 5, the brightness of the lighting that lights up the 3D object 5, and the shade made on the 3D object 5 are considered as elements that largely influence the crosstalk, and information including them is presented to the user.

It can also be said that this is processing of selecting and presenting elements that effectively contribute to crosstalk reduction from various elements in the 3D content 6 that can cause the crosstalk. Accordingly, the user can efficiently perform adjustment that leads to crosstalk reduction.

### [Calculation for Crosstalk-Related Parameters for Each Pixel]

Hereinafter, calculation processing for the crosstalk-related parameters by the region information conversion unit 44 performed in Step 103 will be described. This processing is aimed at associating elements in the 3D content 6 that cause the crosstalk with the respective pixels of the crosstalk-predicted region 11 predicted for each of the parallax images 2 (left-eye image 2L and right-eye image 2R).

The elements (elements extracted for each pixel) in the 3D content 6 associated with each pixel are the above-mentioned crosstalk-related parameters (the color information, the lighting information, and the shading information) at the position x corresponding to the pixel that is a processing target.

In addition, information other than the color information, the lighting information, and the shading information may be extracted as crosstalk-related parameters. In this case, for example, a three-dimensional coordinate value of the position x, an ID of the 3D object to which it belongs, and the like are extracted.

In the calculation processing for the crosstalk-related parameters, a three-dimensional model obtained by arranging, in the three-dimensional space in which the 3D objects 5 are arranged, the observation viewpoints Q (left-eye viewpoint QL and right-eye viewpoint QR) that are the estimated positions of the left and right eyes and the display surface 26 on which the parallax images 2 (left-eye image 2L and right-eye image 2R) are displayed is used. That is, in the three-dimensional space in which the 3D object 5 and the observation viewpoint Q are arranged sandwiching the display surface 26, the crosstalk-related parameters are extracted for each pixel of the crosstalk-predicted region 11.

Hereinafter, two methods will be described as the calculation processing for the crosstalk-related parameters.

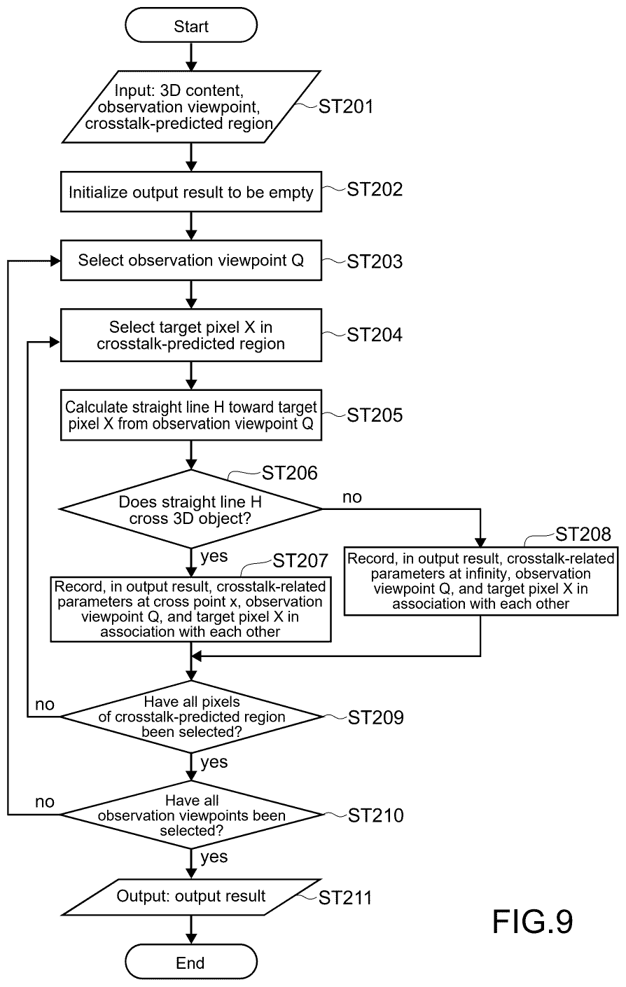

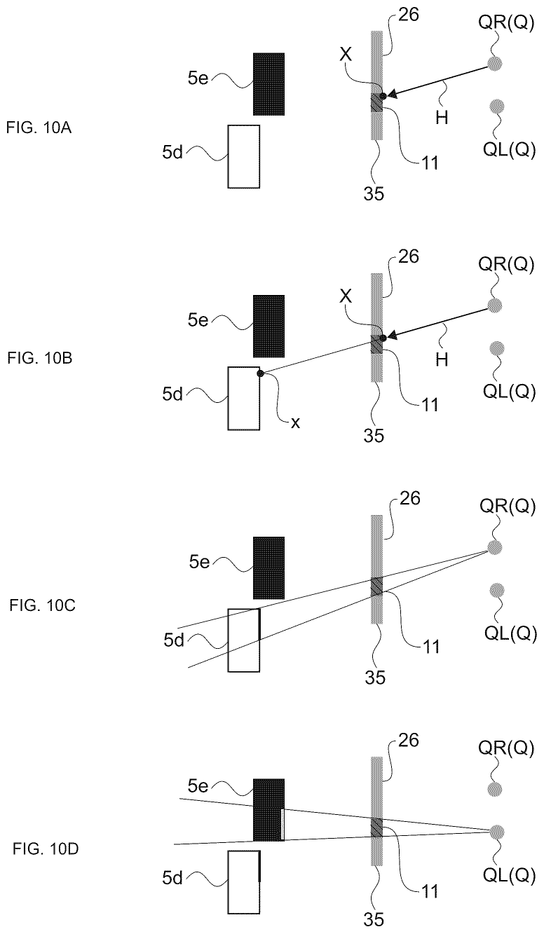

FIG. 9 is a flowchart showing an example of the calculation processing for the crosstalk-related parameters. FIG. 10 is a schematic view for describing the processing shown in FIG. 9. The processing shown in FIG. 9 is internal processing in Step 103 shown in FIG. 7. Moreover, in A of FIG. 10 to D of FIG. 10, processing in the three-dimensional space in which the display surface 26, the left-eye viewpoint QL and the right-eye viewpoint QR that are the observation viewpoints Q, and two 3D objects 5d and 5e are arranged is schematically shown as a plan view.

The processing shown in FIGS. 9 and 10 is a method of repeating an operation of emitting a light beam to a point in the crosstalk-predicted region 11 (hereinafter, referred to as a target pixel X) from the observation viewpoint Q and checking an intersection of a straight line H that is an optical path of the light beam with the 3D object 5 in the 3D content 6, thereby calculating correspondence.

Hereinafter, it will be described specifically.

As shown in FIG. 9, first of all, data of the 3D content 6, data of the two or more observation viewpoints Q, and data of the crosstalk-predicted region 11 are input to the region information conversion unit 44 (Step 201).

Next, a data set (output data 35) to input the output result is initialized (Step 202). For example, a data array capable of recording a plurality of crosstalk-related parameters for each pixel is prepared and an initial value is substituted as a value of each parameter.

Next, one observation viewpoint Q of the two or more observation viewpoints Q is selected (Step 203).

Next, a target pixel X that is a processing target is selected from pixels included in the crosstalk-predicted region 11 in the parallax image 2 corresponding to the selected observation viewpoint Q (Step 204).

Next, the straight line H toward the target pixel X from the observation viewpoint Q is calculated (Step 205). In A of FIG. 10, the straight line H is shown by the arrow toward the target pixel X on the display surface 26 from the observation viewpoint Q (here, the right-eye viewpoint QR). The target pixel X is a pixel included in the crosstalk-predicted region 11R (in the figure, hatched region) visible from the right-eye viewpoint QR. The straight line H is a straight line in the three-dimensional space and is calculated on the basis of the three-dimensional coordinates of the observation viewpoint Q and the three-dimensional coordinates of the target pixel X. It should be noted that the three-dimensional coordinates of the target pixel X are coordinates or the like of a center position of the target pixel X in the three-dimensional space.

Next, whether or not the straight line H crosses the 3D object 5 is determined (Step 206). For example, whether or not the 3D object 5 is present on the straight line H is determined.

For example, it is assumed that the straight line H crosses the 3D object 5 (Yes in Step 206). In this case, data of the 3D object 5 crossing the straight line H is extracted as crosstalk-related parameters at the target pixel X (Step 207).

First of all, an initial cross point x between the straight line H and the 3D object 5 is calculated and the crosstalk-related parameters with respect to the cross point x are read out. The read-out data is recorded in the output data 35 in association with information about the observation viewpoint Q and the target pixel X.

In B of FIG. 10, a state in which the straight line H calculated in A of FIG. 10 crosses the white 3D object 5d is shown. When the cross point x where the straight line H and the 3D object 5d first cross each other is calculated, the data of the 3D object 5d at the cross point x is referenced. Specifically, the color information, the lighting information, and the shading information at the cross point x are read out and recorded as crosstalk-related parameters at the target pixel X included in the crosstalk-predicted region 11R visible from the right-eye viewpoint QR.

Referring back to FIG. 9, it is assumed that the straight line H does not cross the 3D object 5 (No in Step 206). In this case, data about an object representing infinity (here, a wall surface, a floor, or the like that is the background in the 3D object 5) is extracted as crosstalk-related parameters at the target pixel X (Step 208). For example, the color information or the like is read with respect to the object representing the infinity and is recorded in the output data 35 in association with the information about the observation viewpoint Q and the target pixel X.

Next, whether or not all pixels of the crosstalk-predicted region 11 have been selected as target pixels X is determined (Step 209). In a case where a pixel has not been selected as the target pixel X (No in Step 209), Step 204 is performed again and a new target pixel X is selected.

In the loop of Step 204 to 209, data in which the crosstalk-related parameters are associated with each pixel of the crosstalk-predicted region 11 with respect to one observation viewpoint Q is generated. For example, in C of FIG. 10, data in which the crosstalk-related parameters are recorded with respect to all pixels of the crosstalk-predicted region 11R visible from the right-eye viewpoint QR is generated. By using this data, for each pixel of the crosstalk-predicted region 11R, it is possible to easily check a parameter that is a main cause of the crosstalk.

Referring back to FIG. 9, in a case where all pixels have been selected as target pixels X (Yes in Step 209), whether or not the all observation viewpoints Q have been selected is determined (Step 210). In a case where an observation viewpoint Q has not yet been selected (No in Step 210), Step 203 is performed again and a new observation viewpoint Q is selected.

For example, as in A of FIG. 10 to C of FIG. 10, in a case where the right-eye viewpoint QR is initially selected as the observation viewpoint Q, the left-eye viewpoint QL is selected in the next loop. In this case, as shown in D of FIG. 10, data in which the crosstalk-related parameters are recorded with respect to all pixels of the crosstalk-predicted region 11L visible from the left-eye viewpoint QL is generated.

It should be noted that in a case where a plurality of observation positions P is set and a plurality of sets of the left-eye viewpoint QL and the right-eye viewpoint QR is present, processing of associating the crosstalk-related parameters with all pixels in the corresponding crosstalk-predicted region 11 is performed with respect to the all observation viewpoints Q.

In a case where the all observation viewpoints Q have been selected (Yes in Step 210), the output data is stored in the storage unit 32 or the like (Step 211).

In this manner, the region information conversion unit 44 calculates the cross point x where the straight line H (light beam) toward a target point X in the crosstalk-predicted region 11 from the observation viewpoint Q first crosses the 3D object 5 in the three-dimensional space in which the 3D object 5 and the observation viewpoint Q are arranged sandwiching the display surface 26 and associates the crosstalk-related parameters at the cross point x with the target pixel X in the crosstalk-predicted region 11. The data in which the crosstalk-related parameters are associated with each pixel is referenced as appropriate when the crosstalk-related parameters are presented on the editing screen 50.

In this processing, only the target pixel X of the pixels included in the display surface 26, which is in the crosstalk-predicted region 11, is set as a processing target. Therefore, for example, as compared to a case where all pixels of the display surface 26 are operated, it is possible to rapidly generate necessary data with a low processing load.

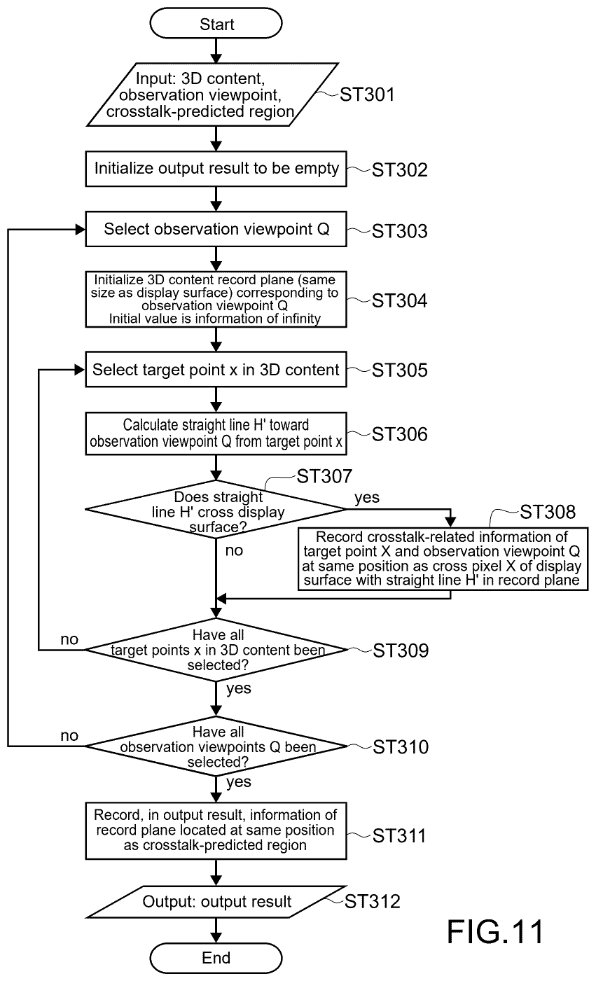

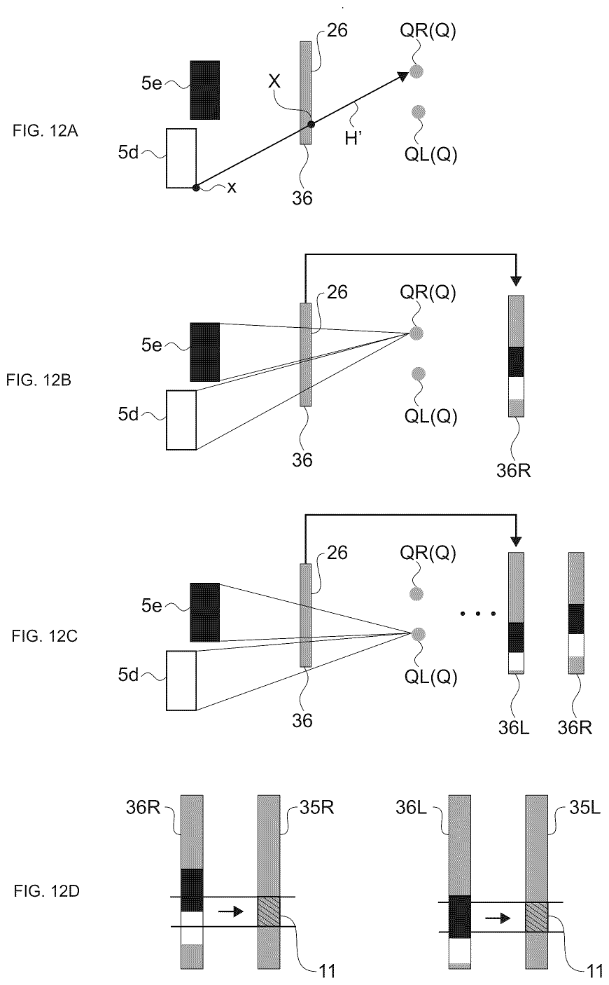

FIG. 11 is a flowchart showing another example of the calculation processing for the crosstalk-related parameters. FIG. 12 is a schematic view for describing the processing shown in FIG. 11.

The processing shown in FIGS. 11 and 12 is a method of transferring the element in the 3D content 6 to the display surface 26 on which the parallax images 2 are displayed and calculating correspondence between each element and the crosstalk-predicted region on its plane. This is processing in which the crosstalk-related parameters corresponding to each point are mapped on the display surface 26 by scanning each point of the 3D content 6 in advance, and then are associated with the respective pixels of the crosstalk-predicted region 11.

Hereinafter, it will be described specifically.

As shown in FIG. 11, first of all, data of the 3D content 6, data of the two or more observation viewpoints Q, and data of the crosstalk-predicted region 11 are input to the region information conversion unit 44 (Step 301).

Next, the data set (output data 35) to input the output result is initialized (Step 302). For example, a data array capable of recording a plurality of crosstalk-related parameters for each pixel is prepared and an initial value is substituted as a value of each parameter.

Next, one observation viewpoint Q of the two or more observation viewpoints Q is selected (Step 303).

Next, a data set (record plane data 36) for configuring a record plane to which the same pixel size as the display surface 26 has been set is prepared (Step 304). The record plane is configured to be capable of recording any parameters for each pixel. For each pixel in the record plane, data about the color information or the like of the object representing infinity (a wall surface, a floor, or the like) is recorded as the initial parameter.

Next, a target point x that is a processing target is selected from each point in the 3D content 6 (Step 305). The target point x is, for example, a point in a surface of the 3D object 5 included in the 3D content 6. At that time, for example, a point located in a position visible from the observation viewpoint Q may be selected as the target point x. Moreover, in a case where the surface of the 3D object 5 is segmented at a predetermined resolution, a representative point of the segmented regions may be selected as the target point x.

Next, a straight line H′ toward the observation viewpoint Q from the target point x is calculated (Step 306). In A of FIG. 12, the straight line H toward the observation viewpoint Q (here, the right-eye viewpoint QR) from the target point x on the white 3D object 5d is shown by using the arrow. The straight line H′ is calculated on the basis of the three-dimensional coordinates of the target point x and the three-dimensional coordinates of the observation viewpoint Q.

Next, whether or not the straight line H′ crosses the display surface 26 is determined (Step 307).

For example, it is assumed that the straight line H′ crosses the display surface 26 (Yes in Step 307). In this case, a cross pixel X positioned at a cross point of the straight line H′ with the display surface 26 is calculated. Then, the crosstalk-related parameters at the target point x and the information about the observation viewpoint Q are recorded as data of a pixel located at the same position as the cross pixel X in the record plane data 36 (Step 308). When processing of recording to the record plane data 36 is completed, Step 309 is performed.

For example, in A of FIG. 12, the cross pixel X where the straight line H′ extending to the right-eye viewpoint Q from the target point x on the white 3D object 5d crosses the display surface 26 is calculated. In this case, the crosstalk-related parameters at the target point x (e.g., the color information, the lighting information, and the shading information of the 3D object 5d) are read out and are recorded as data at the same position as the cross pixel X in the record plane data 36 together with data of the right-eye viewpoint QR. At that time, data recorded as the initial value at the same position as the cross pixel X is deleted.

Meanwhile, depending on the position of the observation viewpoint Q, the straight line H′ extending to the observation viewpoint Q from the target point x does not cross the display surface 26. In this manner, in a case where the straight line H′ does not cross the display surface 26 (No in Step 307), Step 309 is performed as it is.

In Step 309, whether or not to all target points x have been selected in the 3D content 6 is determined. In a case where a target point x has not been selected (No in Step 309), Step 305 is performed again and a new target point x is selected.

In the loop from Step 305 to 309, the record plane data 36 is generated by mapping the crosstalk-related parameters at each point (target point x) in the 3D content 6 visible from one observation viewpoint Q on the display surface 26. For example, in B of FIG. 12, record plane data 36R for the right-eye viewpoint QR is generated.

As to this data, when the 3D content 6 is viewed from the right-eye viewpoint QR, the crosstalk-related parameters at each target point x on the 3D object 5d are recorded in a region on the display surface 26 (a white region in the record plane data 36R) through which light toward the 3D object 5d passes. Also, the crosstalk-related parameters at each target point x on the 3D object 5e are recorded in the region on the display surface 26 (a black region in the record plane data 36R) through which light toward a 3D object 5e passes.

Referring back to FIG. 11, in a case where all target points x have been selected (Yes in Step 309), whether or not the all observation viewpoints Q have been selected is determined (Step 310). In a case where an observation viewpoint Q has not been selected (No in Step 310), Step 303 is performed again and a new observation viewpoint Q is selected.

For example, as in A of FIG. 12 and B of FIG. 12, in a case where the right-eye viewpoint QR is initially selected as the observation viewpoint Q, the left-eye viewpoint QL is selected in the next loop. In this case, as shown in C of FIG. 12, record plane data 36L for the left-eye viewpoint QL is generated by mapping the crosstalk-related parameters at each point of the 3D content 6 visible from the left-eye viewpoint QL on the display surface 26.

It should be noted that in a case where a plurality of observation positions P is set and a plurality of sets of the left-eye viewpoint QL and the right-eye viewpoint QR is present, processing of generating the corresponding record plane data 36 is respectively performed with respect to the all observation viewpoints Q.

In a case where the all observation viewpoints Q have been selected (Yes in Step 310), the crosstalk-related parameters corresponding to each pixel of the crosstalk-predicted region 11 are read from the record plane data 36 and are recorded in the output data (Step 311). In D of FIG. 12, processing of generating the output data from the record plane data 36 is schematically shown.

In the figure on the left-hand side of D of FIG. 12, output data 35R for the right-eye viewpoint QR is generated from the record plane data 36R of the right-eye viewpoint QR generated in B of FIG. 12. In this case, the crosstalk-related parameters with respect to each of the pixels included in the crosstalk-predicted region 11R visible from the right-eye viewpoint QR in the record plane data 36R are extracted as the output data 35R.

Moreover, in the figure on the right-hand side in D of FIG. 12, output data 35L for the left-eye viewpoint QL is generated from the record plane data 36L of the left-eye viewpoint QL generated in C of FIG. 12. In this case, the crosstalk-related parameters with respect to each of the pixels included in the crosstalk-predicted region 11L visible from the left-eye viewpoint QL in the record plane data 36L are extracted as the output data 35L.

These processes are performed for each observation viewpoint Q and the generated output data 35 is stored in the storage unit 32 or the like (Step 312).

In this manner, in the processing shown in FIGS. 11 and 12, the cross pixel X arranged at the cross point where the straight line H toward the observation viewpoint Q from the target point x on the 3D object 5 crosses the display surface 26 in the three-dimensional space where the 3D objects 5 and the observation viewpoints Q are arranged sandwiching the display surface 26 is calculated and the crosstalk-related parameters at the target point x are associated with the cross pixel X, such that the crosstalk-related parameters on the display surface 26 are mapped. Then, the crosstalk-related parameters are associated with each pixel in the crosstalk-predicted region 11 on the basis of a result of the mapping.

In this processing, the crosstalk-related parameters corresponding to each pixel in the crosstalk-predicted region 11 are extracted from the record plane data 36 obtained by mapping the crosstalk-related parameters. Therefore, for example, even in a case where the crosstalk-predicted region 11 slightly changes due to changes in the crosstalk determination conditions and the like, the use of the record plane data 36 enables necessary output data 35 to be easily generated. Accordingly, it is possible to easily create content corresponding to various situations.

### [Presentation of Crosstalk-Related Images]

FIG. 13 is a schematic view showing a presentation example of the crosstalk-related image 10. In FIG. 13, a plurality of types of crosstalk-related images 10 is presented on the editing screen 50. Numbers #1 to #4 surrounded by the dotted-line rectangle are indices shown for describing the editing screen 50. It should be noted that these indices are not displayed on the actual editing screen 50.

Here, the crosstalk-related image 10 with respect to crosstalk that can be perceived at one observation viewpoint Q of the pair of observation viewpoints Q (left-eye viewpoint QL and right-eye viewpoint QR) depending on the observation position P is presented.

As shown in #1, in the present embodiment, a list of the 3D objects 5 that cause the crosstalk is presented as the crosstalk-related images 10. For example, a list window 52 for displaying the list of the 3D objects 5 in the periphery of the free-viewpoint window 51 is displayed.

For example, the 3D objects 5 included in the output data created by the region information conversion unit 44 are picked up and the list of the 3D objects 5 that cause the crosstalk is generated. IDs, object names, or the like of the respective 3D objects 5 included in this list are displayed on the list window 52.

In the example shown in FIG. 13, a cylindrical object 5f and a back surface object 5g of the 3D objects 5 included in the 3D content 6, which is arranged on its back side and forms the back surface of the content, are displayed as a list.

Moreover, when an ID, an object name, or the like displayed on the list window 52 is selected, processing by which the corresponding 3D object 5 is displayed in a highlighted manner on the free-viewpoint window 51 may be performed. In contrast, in a case where a 3D object 5 is selected in the free-viewpoint window 51 and the object is included in the list, it is also possible to display an ID, an object name, or the like in the list window 52 in a highlighted manner.

Presenting the list of the 3D objects 5 that cause the crosstalk in this manner allows the user to clearly understand which 3D object 5 should be edited to reduce the crosstalk. Thus, the user can efficiently proceed the editing work.

As shown in #2, in the present embodiment, a crosstalk-predicted region 11 is presented as the crosstalk-related image 10. At that time, an image representing the crosstalk-predicted region 11 is displayed along the 3D object 5 on the editing screen 50.

Here, in the free-viewpoint window 51, an object representing the crosstalk-predicted region 11 (hereinafter, referred to as a region display object 53) is displayed along the cylindrical object 5f and the back surface object 5g.

The region display object 53 is, for example, a stereoscopic object formed by projecting the crosstalk-predicted region 11 calculated as a region on the parallax images 2 (display surface 26) in the three-dimensional space in which the 3D objects 5 are arranged. Thus, it is possible to change the viewpoint like other objects and check the region display object 53 by moving a camera viewpoint in the free-viewpoint window 51. That is, the region display object 53 is handled as the 3D object representing the crosstalk-predicted region 11. Accordingly, it is possible to display a site that causes the crosstalk on the editing screen 50 in an understandable manner.

Hereinabove, the crosstalk-predicted region 11 visible from one observation viewpoint Q is displayed. As described above with reference to FIGS. 5 and 6 and the like, the crosstalk-predicted region 11 visible from the one observation viewpoint Q is a region where light of the parallax image 2 displayed at the other observation viewpoint Q is mixed. Thus, it can be said that for example, in the parallax image 2 at the other observation viewpoint Q, a region overlapping the crosstalk-predicted region 11 with respect to the one observation viewpoint Q is a region that causes the crosstalk.

Such a region that causes the crosstalk may be displayed in the free-viewpoint window 51 or the like together with the crosstalk-predicted region 11. Accordingly, the region that causes the crosstalk is displayed, and thus it becomes possible to make the editing work sufficiently efficient.

As shown in #3, in the present embodiment, crosstalk-related parameters are presented as the crosstalk-related image 10.

Here, a balloon-type icon 54 for displaying the crosstalk-related parameters is displayed. Then, a color of the object (color information), a color of the lighting (lighting information), intensity of the shade (shading information), and luminance of the parallax image 2 are displayed as the crosstalk-related parameters inside the icon 54. Although such information is expressed in a RGB format, another format may be used. Moreover, a dedicated window and the like may be used instead of the icon 54.

Moreover, in the present embodiment, the crosstalk-related parameters corresponding to a specified point 55 specifying the user in the parallax image 2 shown in #4 are displayed. The specified point 55 is, for example, a specified point by the user using a mouse or a touch panel.

For example, on the basis of the coordinates of the specified point 55 in the parallax image 2, a pixel X specifying the specified point 55 is calculated. Then, the crosstalk-related parameters associated with the pixel X are read out from the output data created by the region information conversion unit 44 and are displayed inside the icon. It should be noted that not a point specified in the parallax image 2, but a point representing the surface or the like of the specified object in the free-viewpoint window 51 may be used as the specified point 55. That is, the specified point 55 may be directly set in the free-viewpoint window 51.

Accordingly, it becomes possible to rapidly present the crosstalk-related parameters at the position that the user wishes to check.

Moreover, in a case of presenting a plurality of crosstalk-related parameters, a parameter of the crosstalk-related parameters, which is to be edited, may be determined and the parameter to be edited may be presented in a highlighted manner. In the example shown in FIG. 13, the item “the color of the object” that is the color information is displayed as thick letters surrounded by black lines. Accordingly, the color information is highlighted as the parameter to be edited.

The method of highlighting the parameter is not limited, and the color and font of the letters may be changed or the letters may be displayed by using the animation. Moreover, highlighted display using an icon, a badge, or the like indicating that it is the parameter to be edited may be performed.

For example, the parameter that influences the occurrence of crosstalk the most is determined and presented as the parameter to be edited.

A method of selecting a parameter with the lowest value can be used as a method of determining such a parameter. For example, in a case where the lighting is bright while the color is dark, it is possible to reduce a luminance difference from a parallax image for another viewpoint by brightening the color. As result, the occurrence of crosstalk can be suppressed.

Moreover, a parameter to easily increase the luminance if the current value is changed may be suggested, for example, on the basis of Expression (1) above.

Moreover, in a case where parameters or the like that may be edited are set as editing conditions, the parameters to be edited or the like may be presented in a highlighted manner on the basis of the conditions. Moreover, parameters or the like that should not be edited may be presented in an understandable manner.

Moreover, the parameters may be presented together with a suggested correction plan. For example, in a case where it is necessary to increase the value of the parameter to be edited, an icon or the like indicating that the value of that parameter should be raised may be presented.

Each crosstalk-related parameter may be presented so that the value of each parameter can be edited. In this case, it is possible to select the value of the parameter displayed in the balloon-type icon 54 or the like and directly input the numeric value. As a matter of course, it is also possible to input the value of the crosstalk-related parameter from the window or the like representing properties of the selected 3D object 5.

Hereinabove, the crosstalk-related parameters at the specified point 55 specified by the user are displayed. This specified point 55 is a point that specifies the pixel X in the crosstalk-predicted region 11 visible from the one observation viewpoint Q. For example, when the pixel X is seen from the other observation viewpoint Q, a point different from the specified point 55 is visible. The point visible from the other observation viewpoint Q is a point that causes the crosstalk at the specified point 55.

In this manner, the point that causes the crosstalk may be displayed together with the specified point 55. Moreover, the crosstalk-related parameters at the point that causes the crosstalk may be displayed together with the crosstalk-related parameters at the specified point 55. Accordingly, the point that causes the crosstalk and its crosstalk-related parameters are displayed, and thus it becomes possible to make the editing work sufficiently efficient.

As shown in #4, the parallax image 2 displayed at the observation viewpoint Q that is a processing target is displayed on the display surface. It should be noted that both the paired parallax images 2 (left-eye image 2L and right-eye image 2R) may be displayed.

In this manner, in the present embodiment, at least one of the left-eye image 2L or the right-eye image 2R depending on the observation position P is presented on the editing screen 50. Moreover, the editing contents of the user are successively reflected in these images. Accordingly, it becomes possible to proceed the editing work while checking a state of the left-eye image 2L (or the right-eye image 2R) actually presented to the user.

Moreover, the crosstalk-predicted region 11 visible from the observation viewpoint Q is displayed, superimposed in the parallax image 2. One obtained by projecting the crosstalk-predicted region 11 displayed here onto the three-dimensional space is the region display object 53 displayed in a free space.

Moreover, as described above, the user can select any position as the specified point 55 in the parallax image 2. The specified point 55 set in the parallax image 2 is projected onto the three-dimensional space and is presented as the point in the free-viewpoint window 51.

Accordingly, the user can proceed the work while checking both the parallax images 2 of the 3D content 6 and a free-viewpoint image. Thus, it becomes possible to make the editing work for suppressing the crosstalk efficient.

Hereinabove, in the information processing apparatus 40 according to the present embodiment, the crosstalk-related image 10 is presented on the basis of the parameters of the pixels corresponding to each other in the left-eye image 2L and the right-eye image 2R that constitute the stereoscopic image as information about the crosstalk that occurs when the stereoscopic image depending on the observation position P is presented. Accordingly, it is possible to support content creation so that crosstalk in a stereoscopic vision can be suppressed.

In the system that presents the stereoscopic image depending on the observation position, a virtual stereoscopic object can be observed in various directions. The content that displays such a stereoscopic object includes a number of editable elements such as parameters related to the lighting (color, intensity, orientation) and arrangement relationship and motion of the respective objects in addition to parameters related to the object itself (e.g., color, texture, and shape).

Therefore, for example, even in a case where the occurrence of crosstalk can be predicted, it is difficult to intuitively realize an element that should be edited to suppress its crosstalk and there is a possibility that creation of the 3D content or the like considering the crosstalk is prevented as a result.

In the present embodiment, the crosstalk-related image related to the crosstalk is presented using the parameters of the pixels corresponding to each other in the left-eye image 2L and the right-eye image 2R depending on the observation position P. Accordingly, a 3D content creator can easily check information about an element or the like that causes its crosstalk with respect to crosstalk that occurs in accordance with the observation position P. As a result, it becomes possible to sufficiently support the creation work of the content considering the crosstalk.

Moreover, in the present embodiment, output data in which the elements (crosstalk-related parameters) in the 3D content 6 that cause the crosstalk are associated with the crosstalk-predicted region 11 predicted on the display surface 26 is generated. Making use of such data, for example, enables an element or the like that should be edited to be rapidly presented on the editing screen 50. Thus, it becomes possible to realize the editing work with less stress.

Moreover, the crosstalk-related parameters are set on the basis of Expression (1) described above. Therefore, the user can present an element directly associated with crosstalk reduction which can be assumed based on a method of generating the parallax images 2 based on the 3D content 6. Accordingly, even with respect to the 3D content 6 with many editable elements, the user can perform the editing work to reduce the crosstalk without confusion.

### Second Embodiment

An information processing apparatus according to a second embodiment of the present technology will be described. Hereinafter, descriptions of portions similar to the configuration and actions in the information processing apparatus 40 described in the above embodiment will be omitted or simplified.

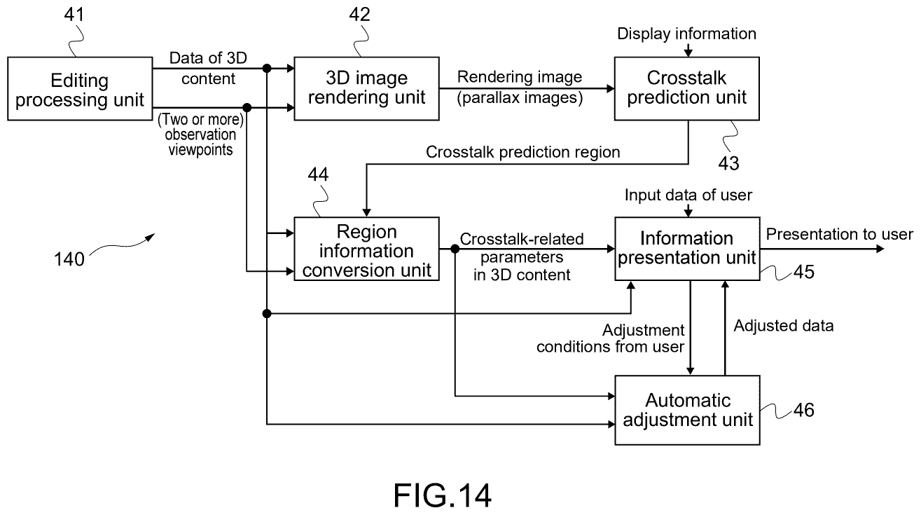

FIG. 14 is a block diagram showing a configuration example of the information processing apparatus according to the second embodiment.

As shown in FIG. 14, an information processing apparatus 140 has a configuration obtained by adding an automatic adjustment unit 46 to the information processing apparatus 40 described above with reference to FIG. 2 and the like. Hereinafter, functional blocks other than the automatic adjustment unit 46 will be described by using the same reference signs as the information processing apparatus 40.

The automatic adjustment unit 46 adjusts the 3D content 6 to suppress crosstalk. That is, the automatic adjustment unit 46 is a block that automatically edits the 3D content 6 to reduce its crosstalk.

For example, the data of the 3D content 6 output from the editing processing unit 41, the data (output data) of the crosstalk-related parameters associated with the 3D content 6 output from the region information conversion unit 44, and data of adjustment conditions input from the user are input to the automatic adjustment unit 46. Based on such data, the 3D content 6 is automatically adjusted.

The automatic adjustment unit 46 typically adjusts crosstalk-related parameters (color information, lighting information, shading information of the 3D object 5) of various parameters included in the 3D content 6. It should be noted that parameters other than the crosstalk-related parameters may be adjusted.

Moreover, the automatic adjustment unit 46 reflects an adjustment result of each parameter to the entire 3D content 6 and outputs it to the adjusted data of the 3D content 6. It should be noted that only the adjusted data of the parameter may be output.

The adjusted data output from the automatic adjustment unit 46 is input to the information presentation unit 45 and is presented on the editing screen 50 as appropriate. For example, the adjusted 3D content 6 is displayed to the free-viewpoint window 51. Alternatively, only the adjusted data may be presented without reflecting the adjustment result to the 3D content 6. Moreover, the values before and after adjustment may be respectively presented. Moreover, an adjusted parameter of a plurality of parameters may be presented in an understandable manner.

As described above, in the present embodiment, the automatic adjustment unit 46 acquires the adjustment conditions of the 3D content 6 and adjusts the 3D content 6 to satisfy the adjustment conditions.

The adjustment conditions include, for example, parameters to be adjusted in the automatic adjustment, an adjustment method used for the automatic adjustment, and information specifying various thresholds and the like. The adjustment conditions are input from the user, for example, via the editing screen 50. Alternatively, default adjustment conditions and the like may be read.

For example, in a case where a parameter group to be adjusted has been set to the adjustment conditions, the parameter group is automatically adjusted. In contrast, in a case where a parameter group for which parameter change by the automatic adjustment is not performed has been set to the adjustment conditions, parameters other than it are automatically adjusted.

Moreover, in a case where there is a plurality of types of processing for the automatic adjustment, the user can specify by which way the automatic adjustment should be performed as an adjustment condition.

Here, an example of the processing of the automatic adjustment will be described. As described above with reference to FIGS. 5 and 6 and the like, the crosstalk occurs, for example, due to a luminance difference between the left-eye image 2L and the right-eye image 2R. Therefore, crosstalk easily occurs, for example, in a case where the 3D object 5 has an extremely high or low luminance. In view of this, an upper limit and a lower limit are set to the luminance value of the 3D object 5 and the luminance value of each object is adjusted to decrease in a case where the current luminance value is higher than the upper limit or to increase in a case where the current luminance value is lower than the lower limit.

At the time of adjustment of the luminance value, a program to solve the existing optimization problem can be used. For example, all editable parameters of the respective parameters to change the luminance value, such as the color, the lighting, and the shade of the 3D object 5, are adjusted and the luminance value is optimized. Moreover, in a case where parameters uneditable under the adjustment conditions and the like, a range of values that can be set, and the like have been specified, the parameters are adjusted in a range of their conditions.

In addition, rule-based adjustment processing, e.g., adjusting parameters in ascending order of values from the parameter with the smallest value may be used instead of the optimization processing.

By automatically adjusting the respective parameters of the 3D content 6 in this manner, it becomes possible to easily create content with crosstalk suppressed only by the user checking the content and/or finely adjusting the parameters. Accordingly, it becomes possible to significantly reduce working time and the like required for editing the content.

### Other Embodiments

The present technology is not limited to the above-mentioned embodiments, and various other embodiments can be realized.

Hereinabove, the crosstalk that occurs between the left-eye and right-eye images mainly assuming one observation position has been described. For example, it is also possible to present, to two or more observers, stereoscopic images depending on the respective observation positions. In this case, left and right parallax images are displayed for each observer on the display panel of the 3D display.

In this case, light from the parallax images of one observer may be mixed in the parallax images of the other observer, and crosstalk can also occur due to this.

Therefore, for example, if a plurality of parallax images 2 corresponds to the plurality of observation positions P, then pairs of images may be selected in a brute force manner and the crosstalk-related image may be displayed with respect to each pair. Moreover, with respect to one parallax image, a crosstalk region or the like calculated by comparison with all other parallax images may be displayed.

Moreover, for example, in a case where the assumed observation position P is determined in advance, for example, it is also possible to assess crosstalk only with respect to a pair of observation positions P that easily causes crosstalk rather than assessing crosstalk with respect to a pair of observation positions P in a positional relationship that hardly causes crosstalk.

In addition, any method capable of assessing crosstalk on the basis of the plurality of parallax images 2 may be used.

Hereinabove, processing of associating the crosstalk-related parameters with each pixel of the crosstalk-predicted region has been described. For example, processing of associating the crosstalk-predicted region with crosstalk-related parameters integrated in the region may be performed. In this case, for example, an object that should be edited for each crosstalk-predicted region and its parameters and the like are displayed.

Accordingly, information that the user should check is organized, such that the user can adjust the parameters without confusion.

The editing display of the above-mentioned content-editing apparatus is a monitor for displaying the two-dimensional image. For example, a 3D display capable of stereoscopic vision display may be used as the editing display. Accordingly, it is possible to perform the editing work while actually checking the edited content in a stereoscopic vision. As a matter of course, the 3D display and the display for the two-dimensional image may be both used.

Moreover, a program according to the present technology may be configured as an extensible program that can be added to an application capable of editing the 3D content 6. For example, the program according to the present technology may be configured as an extensible program that can be applied to an application capable of editing a 3D space, such as Unity (registered trademark) or Unreal Engine (registered trademark). Alternatively, the program according to the present technology may be configured as the editing application of the 3D content 6 itself. Moreover, the present technology may be applied to an browsing application or the like for checking the content data 34 of the 3D content 6.

Hereinabove, an information processing method according to the present technology is executed by the information processing apparatus used by the user who is a content producer. The present technology is not limited thereto, and by cooperation of the information processing apparatus used by the user with another computer capable of communicating therewith via a network or the like, the information processing method and the program according to the present technology are performed and the information processing apparatus according to the present technology may be configured.

That is, the information processing method and the program according to the present technology may be performed not only in a computer system configured by a single computer but also in a computer system in which a plurality of computers cooperatively operate. It should be noted that in the present disclosure, the system means a set of a plurality of components (apparatus, module (parts), and the like) and it does not matter whether or not all the components are housed in the same casing. Therefore, both of a plurality of apparatuses housed in separate casings and connected to one another via a network and a single apparatus having a plurality of modules housed in a single casing are the system.

Performing the information processing method and the program according to the present technology by the computer system includes, for example, both of a case where a single computer performs presentation of the crosstalk-related image and the like and a case where different computers perform the respective processes. Moreover, performing the respective processes by a predetermined computer includes causing another computer to perform some or all of those processes and acquiring the results.

That is, the information processing method and the program according to the present technology can also be applied to a cloud computing configuration in which a plurality of apparatuses shares and cooperatively processes a single function via a network.

At least two of the features of the present technology described above may be combined. That is, the various features described in the respective embodiments may be arbitrarily combined across the respective embodiments. Moreover, the above-mentioned various effects are merely exemplary, not limitative, and other effects may be exerted.

In the present disclosure, “the same,” “equal,” “orthogonal,” and the like are concepts including “substantially the same,” “substantially equal,” “substantially orthogonal,” and the like. For example, states included in a predetermined range (e.g., range of ±10%) based on “completely the same,” “completely equal,” “completely orthogonal,” and the like are also included.

It should be noted that the present technology can also take the following configurations.

(1) An information processing apparatus, including
a presentation unit that presents a crosstalk-related image related to crosstalk due to presentation of a stereoscopic image on the basis of information about a plurality of parallax images that constitutes a stereoscopic image depending on an observation position.
   (2) The information processing apparatus according to (1), in which
the plurality of parallax images includes a left-eye image and a right-eye image corresponding to the left-eye image, and
the presentation unit presents the crosstalk-related image on the basis of a parameter of a pixel in the left-eye image and a parameter of a pixel in the right-eye image corresponding to the pixel in the left-eye image.
   (3) The information processing apparatus according to (2), in which
the stereoscopic image is an image that displays three-dimensional content including a three-dimensional object, and
the presentation unit presents the crosstalk-related image on an editing screen for editing the three-dimensional content.
   (4) The information processing apparatus according to (3), in which
the presentation unit compares the parameters of the pixels corresponding to each other in the left-eye image and the right-eye image and calculates a crosstalk-predicted region where the crosstalk is predicted to occur.
   (5) The information processing apparatus according to (4), in which
the presentation unit presents the crosstalk-predicted region as the crosstalk-related image.
   (6) The information processing apparatus according to (5), in which
the presentation unit displays an image representing the crosstalk-predicted region along the three-dimensional object on the editing screen.
   (7) The information processing apparatus according to any one of (4) to (6), in which
the parameters of the pixels in the left-eye image and the right-eye image include luminance of the pixels, and
the presentation unit calculates a region where a luminance difference between the pixels in the left-eye image and the right-eye image exceeds a predetermined threshold as the crosstalk-predicted region.
   (8) The information processing apparatus according to (7), in which
the predetermined threshold is set in accordance with properties of a display panel that displays the left-eye image to a left eye of an observer of the stereoscopic image and displays the right-eye image to a right eye of the observer.
   (9) The information processing apparatus according to any one of (4) to (8), in which
the presentation unit presents, as the crosstalk-related image, crosstalk-related parameters of parameters set to the three-dimensional content, the crosstalk-related parameters being related to the crosstalk in the crosstalk-predicted region.
   (10) The information processing apparatus according to (9), in which
the crosstalk-related parameters include at least one of color information, lighting information, or shading information of the three-dimensional object representing the pixels in the left-eye image and the right-eye image.
   (11) The information processing apparatus according to (9) or (10), in which
the presentation unit determines a parameter of the crosstalk-related parameters, which is to be edited, and presents the parameter to be edited in a highlighted manner.
   (12) The information processing apparatus according to any one of (3) to (11), in which
the presentation unit presents the crosstalk-related image for each observation viewpoint including at least one of a left-eye viewpoint or a right-eye viewpoint depending on the observation position.
   (13) The information processing apparatus according to (12), in which
the presentation unit calculates a cross point where a straight line toward a target pixel in the crosstalk-predicted region from the observation viewpoint initially crosses the three-dimensional object in a three-dimensional space in which the three-dimensional object and the observation viewpoint are arranged sandwiching a display surface on which the left-eye image and the right-eye image are displayed and associates the target pixel in the crosstalk-predicted region with the crosstalk-related parameters at the cross point.
   (14) The information processing apparatus according to (12), in which
the presentation unit calculates a cross pixel where a straight line toward the observation viewpoint from a target point on the three-dimensional object is arranged at a cross point crossing the display surface in a three-dimensional space in which the three-dimensional object and the observation viewpoint are arranged by sandwiching a display surface on which the left-eye image and the right-eye image are displayed and associates the crosstalk-related parameters at the target point with the cross pixel, thereby mapping the crosstalk-related parameters on the display surface, and associates each pixel in the crosstalk-predicted region with the crosstalk-related parameters on a basis of a result of the mapping.
   (15) The information processing apparatus according to any one of (3) to (14), in which
the presentation unit adjusts the three-dimensional content so that the crosstalk can be suppressed.
   (16) The information processing apparatus according to (15), in which
the presentation unit acquires adjustment conditions of the three-dimensional content and adjusts the three-dimensional content to satisfy the adjustment conditions.
   (17) The information processing apparatus according to any one of (3) to (16), in which
the presentation unit presents a list of the three-dimensional object that causes the crosstalk as the crosstalk-related image.
   (18) The information processing apparatus according to any one of (2) to (17), in which
the presentation unit presents at least one of the left-eye image or the right-eye image depending on the observation position on the editing screen.
   (19) An information processing method executed by a computer system, including
presenting, on the basis of the information about the plurality of parallax images that constitutes the stereoscopic image depending on the observation position, the crosstalk-related image related to the crosstalk due to presentation of the stereoscopic image.
   (20) A computer-readable recording medium on which a program is recorded, the program for executing
a step of presenting, on the basis of the information about the plurality of parallax images that constitutes the stereoscopic image depending on the observation position, the crosstalk-related image related to the crosstalk due to presentation of the stereoscopic image.

### REFERENCE SIGNS LIST

1 observer
2 parallax image
2L left-eye image
2R right-eye image
5, 5a to 5e 3D object
6 3D content
10 crosstalk-related image
11, 11L, 11R crosstalk-predicted region
20 3D display
26 display surface
32 storage unit
33 control program
34 content data
40, 140 information processing apparatus
41 editing processing unit
42 3D image rendering unit
43 crosstalk prediction unit
44 region information conversion unit
45 information presentation unit
46 automatic adjustment unit
50 editing screen
100 content-editing apparatus

1. An information processing apparatus, comprising
a presentation unit that presents a crosstalk-related image related to crosstalk due to presentation of a stereoscopic image on a basis of information about a plurality of parallax images that constitutes a stereoscopic image depending on an observation position.

2. The information processing apparatus according to claim 1, wherein
the plurality of parallax images includes a left-eye image and a right-eye image corresponding to the left-eye image, and
the presentation unit presents the crosstalk-related image on a basis of a parameter of a pixel in the left-eye image and a parameter of a pixel in the right-eye image corresponding to the pixel in the left-eye image.

3. The information processing apparatus according to claim 2, wherein
the stereoscopic image is an image that displays three-dimensional content including a three-dimensional object, and
the presentation unit presents the crosstalk-related image on an editing screen for editing the three-dimensional content.

4. The information processing apparatus according to claim 3, wherein
the presentation unit compares the parameters of the pixels corresponding to each other in the left-eye image and the right-eye image and calculates a crosstalk-predicted region where the crosstalk is predicted to occur.

5. The information processing apparatus according to claim 4, wherein
the presentation unit presents the crosstalk-predicted region as the crosstalk-related image.

6. The information processing apparatus according to claim 5, wherein
the presentation unit displays an image representing the crosstalk-predicted region along the three-dimensional object on the editing screen.

7. The information processing apparatus according to claim 4, wherein
the parameters of the pixels in the left-eye image and the right-eye image include luminance of the pixels, and
the presentation unit calculates a region where a luminance difference between the pixels in the left-eye image and the right-eye image exceeds a predetermined threshold as the crosstalk-predicted region.

8. The information processing apparatus according to claim 7, wherein
the predetermined threshold is set in accordance with properties of a display panel that displays the left-eye image to a left eye of an observer of the stereoscopic image and displays the right-eye image to a right eye of the observer.

9. The information processing apparatus according to claim 4, wherein
the presentation unit presents, as the crosstalk-related image, crosstalk-related parameters of parameters set to the three-dimensional content, the crosstalk-related parameters being related to the crosstalk in the crosstalk-predicted region.

10. The information processing apparatus according to claim 9, wherein
the crosstalk-related parameters include at least one of color information, lighting information, or shading information of the three-dimensional object representing the pixels in the left-eye image and the right-eye image.

11. The information processing apparatus according to claim 9, wherein
the presentation unit determines a parameter of the crosstalk-related parameters, which is to be edited, and presents the parameter to be edited in a highlighted manner.

12. The information processing apparatus according to claim 3, wherein
the presentation unit presents the crosstalk-related image for each observation viewpoint including at least one of a left-eye viewpoint or a right-eye viewpoint depending on the observation position.

13. The information processing apparatus according to claim 12, wherein
the presentation unit calculates a cross point where a straight line toward a target pixel in the crosstalk-predicted region from the observation viewpoint initially crosses the three-dimensional object in a three-dimensional space in which the three-dimensional object and the observation viewpoint are arranged sandwiching a display surface on which the left-eye image and the right-eye image are displayed and associates the target pixel in the crosstalk-predicted region with the crosstalk-related parameters at the cross point.

14. The information processing apparatus according to claim 12, wherein
the presentation unit calculates a cross pixel where a straight line toward the observation viewpoint from a target point on the three-dimensional object is arranged at a cross point crossing the display surface in a three-dimensional space in which the three-dimensional object and the observation viewpoint are arranged by sandwiching a display surface on which the left-eye image and the right-eye image are displayed and associates the crosstalk-related parameters at the target point with the cross pixel, thereby mapping the crosstalk-related parameters on the display surface, and associates each pixel in the crosstalk-predicted region with the crosstalk-related parameters on a basis of a result of the mapping.

15. The information processing apparatus according to claim 3, wherein
the presentation unit adjusts the three-dimensional content so that the crosstalk can be suppressed.

16. The information processing apparatus according to claim 15, wherein
the presentation unit acquires adjustment conditions of the three-dimensional content and adjusts the three-dimensional content to satisfy the adjustment conditions.

17. The information processing apparatus according to claim 3, wherein
the presentation unit presents a list of the three-dimensional object that causes the crosstalk as the crosstalk-related image.

18. The information processing apparatus according to claim 2, wherein
the presentation unit presents at least one of the left-eye image or the right-eye image depending on the observation position on the editing screen.

19. An information processing method executed by a computer system, comprising
presenting, on a basis of the information about the plurality of parallax images that constitutes the stereoscopic image depending on the observation position, the crosstalk-related image related to the crosstalk due to presentation of the stereoscopic image.

20. A computer-readable recording medium on which a program is recorded, the program for executing
a step of presenting, on a basis of the information about the plurality of parallax images that constitutes the stereoscopic image depending on the observation position, the crosstalk-related image related to the crosstalk due to presentation of the stereoscopic image.
